(19) United States
(12) Patent Application Publication
(10) Pub. No.: US 2026/0073325 A1
(43) Pub. Date: Mar. 12, 2026

(54) POLICY-CONSTRAINED NATURAL-LANGUAGE INTERFACES TO ARTIFICIAL INTELLIGENCE MODELS

(71) Applicant: Cerebri AI Inc., Austin, TX (US)

(72) Inventors: Jean Joseph Belanger, Austin, TX (US); Gabriel Mauricio Silberman, Austin, TX (US); Hongshi Li, Vancouver (CA); Nora Elsa Celis, Liberty Hill, TX (US); Oscar David Villarreal, Toronto (CA); Wemer Mercado Wee, Houston, TX (US); Radek Marik, Husinec-Rez (CZ); Uladzislau Yorsh, Prague (CZ); Steven Lincoln Harter, Virginia Beach, VA (US)

(21) Appl. No.: 19/327,903

(22) Filed: Sep. 12, 2025

Related U.S. Application Data
(60) Provisional application No. 63/694,009, filed on Sep. 12, 2024.

(51) Int. Cl. G06Q 10/0631; G06F 40/174; G06F 40/186; G06F 40/205; G06F 40/40; G06Q 10/02; G06Q 50/14

(52) U.S. Cl. CPC G06Q 10/06315; G06F 40/174; G06F 40/186; G06F 40/205; G06F 40/40; G06Q 10/02; G06Q 50/14

(57) ABSTRACT

Provided is a process, comprising receiving, with a computer system, a natural language request that relates to a travel itinerary; obtaining, with the computer system, a user profile and one or more sets of constraints corresponding to the natural language request; determining, with the computer system, a travel itinerary template, based on the user profile and the one or more sets of constraints; populating, with the computer system, the travel itinerary template with a plurality of travel components based on the user profile and the one or more set of constraints; and presenting, with the computer system, at least some candidate results, the candidate results stored in memory.

### CROSS-REFERENCE TO RELATED APPLICATIONS

This application claims the benefit of U.S. Provisional Pat. App. 63/694,009, titled POLICY-CONSTRAINED NATURAL-LANGUAGE INTERFACES TO ARTIFICIAL INTELLIGENCE MODELS, filed 12 Sep. 2024, the entire content of which is hereby incorporated by reference.

### BACKGROUND

### 1. Field

The present disclosure relates generally to computing and, more specifically, to policy-constrained natural language interfaces to artificial intelligence models.

### 2. Description of the Related Art

Optimization problem with unknown bounds may present difficulties in solving for ideal (e.g., optimum) solutions. In some cases, this may be because the optimization function (e.g., objective function) is poorly behaved, e.g., with multiple local maxima or minima, insufficiently converging, non-continuous, non-convex, etc. Additionally, an optimization function, particularly for a problem where the motivations of the entity for which the problem is to be optimized, may be opaque, including poorly defined or even just poorly understood. In order to provide solutions to optimization problems that users, entities, etc., find useful, various assumptions about the optimization function may be made, in some cases, based on assumed motivations or prior behavior of the given user, entity, etc. However, motivations and behavior may change over time, be constrained by other forces (e.g., market forces, contractual obligations, etc.) and various actors (e.g., users, entities, enterprises, service providers, etc.) may have opposing motivations which may act in opposite directions in an optimization function, including causing non-convergence. Various methods operate to balance these forces, such as by iterative solution provision, where a given solution may then be checked against rules, provided for selection, etc. However, users may find iterative solutions lengthy, cumbersome, etc. and resent (or even be unable to produce) the amount of information input required to generate realistic proposed solutions.

### SUMMARY

The following is a non-exhaustive listing of some aspects of the present techniques. These and other aspects are described in the following disclosure.

Some aspects include a process comprising receiving, with a computer system, a natural language request that relates to a travel itinerary; obtaining, with the computer system, a user profile and one or more sets of constraints corresponding to the natural language request; determining, with the computer system, a travel itinerary template, based on the user profile and the one or more sets of constraints; populating, with the computer system, the travel itinerary template with a plurality of travel components based on the user profile and the one or more set of constraints; and presenting, with the computer system, at least some candidate results, the candidate results stored in memory.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a schematic diagram depicting example preparation and booking phases of a process for creation of an itinerary based on natural language processing, in accordance with some embodiments.

FIG. 2 is a schematic diagram depicting an example user profile and a set of group wide preferences for similar travelers, in accordance with some embodiments.

FIG. 3 is a schematic flowchart depicting an example workflow to create and update a user profile, in accordance with some embodiments.

FIG. 4 is a schematic diagram flowchart depicting an example workflow for creating itinerary templates based on policy rules, in accordance with some embodiments.

FIG. 5 is a schematic diagram depicting an example of constraint identification and generation, in accordance with some embodiments.

FIG. 6 is a schematic diagram depicting a knowledge-augmented model for itinerary creation, in accordance with some embodiments.

FIG. 7 is a schematic diagram depicting example offline and online phases of a process for creation of an itinerary, in accordance with some embodiments.

FIG. 8 is a schematic diagram depicting example offline and online phases of a process for creation of an itinerary which complies with some contractual obligations, in accordance with some embodiments.

FIG. 9 is a schematic diagram depicting parsing of vendor contracts in order to identify contractual obligations for itinerary creation, in accordance with some embodiments.

FIG. 10 is a schematic diagram showing an example data parsing pipeline, in accordance with some embodiments.

FIG. 11 is a schematic diagram depicting parsing of a contract using a multi-agent workflow, in accordance with some embodiments.

FIG. 12 is flowchart of a process for handling natural language ambiguity, in accordance with some embodiments.

FIG. 13 is a system block diagram of an example computing device by which the present techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of computer science and human-computer interaction. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

In a variety of scenarios, engineers may be faced with challenges which require selections among options to be made to maximize unspecified or unknown objective functions, which may be heterogeneous objective functions. In some cases, the selection may be made with the objective functions entirely unknown or even only partially constrained or specified. Examples may include the following:

Discovering new materials or combinations of material that may be optimized for multiple conflicting properties (e.g., strength, weight, thermal resistance, cost, etc.) without knowing the specific needs or applications for which they will be used. This may be done while trying to find a balance of material properties that may maximize the potential application of the material to a broad range of applications without knowing the exact trade-offs desired by future users or applications.

Designing a satellite configuration for Earth observation which may be optimized to provide data coverage and data resolution across various scientific, commercial, and governmental applications without knowing the precise future requirements (e.g., of users). This may be done while seeking to maximize data utility (coverage, resolution, timeliness, etc.) for a broad range of unknown and evolving use cases and constrained cost.

Designing communication networks (e.g., internet infrastructure, cellular networks, etc.) to maximize resilience, speed, and coverage without knowing future user distribution, bandwidth needs, or being able to account technological advancements. This may require optimization, for instance with objectives to ensure network robustness, low latency, and high capacity, which may struggle to account for unknown and changing user demand and technological conditions.

Managing traffic flow through an automated control system in a city without knowing the specific routes, preferences, or urgency of individual drivers. This may be arranged to maximize overall traffic efficiency (e.g., minimizing congestion and travel time) and safety, despite the unknown distribution of driver routes, preferences, and behaviors.

Booking travel itineraries for one or more users by selecting among options for various stages of travel without knowing all of the preferences of different travelers and which preferences are applicable to the selection.

A variety of approaches may be used to address challenges where the objective function is unspecified and may vary among different use cases. Multi-objective optimization algorithms, like genetic algorithms, non-dominated sorting genetic algorithms, multi-objective particle swarm optimization, etc., may aim to find a range of optimal solutions that balance multiple conflicting objectives. Robust optimization approaches, such as worst-case optimization, min-max regret optimization, stochastic programming, etc., may seek solutions that perform well under uncertain conditions. Reinforcement learning (RL), including its multi-agent variants, may facilitate learning optimal strategies through interaction with complex environments where objectives are not fully known. Bayesian optimization may be applied for optimizing expensive-to-evaluate black-box functions by modeling them probabilistically. Heuristic and metaheuristic algorithms, such as simulated annealing, tabu search, and ant colony optimization, may use diverse search strategies to explore complex solution spaces. Ensemble methods, like random forests and boosting techniques, may combine multiple models to capture different aspects of unknown or heterogeneous objectives. Game theory and mechanism design may employ strategic frameworks to handle multiple players with conflicting goals, while adaptive algorithms and active learning may refine models dynamically based on feedback. Data-driven and machine learning-based optimization methods, such as neural networks and decision trees, may approximate complex objective functions using historical data. In another example, preference elicitation and aggregation methods, including conjoint analysis and voting mechanisms, may help to infer and aggregate preferences in situations with multiple stakeholders, guiding decision-making under uncertainty.

In some cases, these optimizations and their corresponding selections may be enhanced with more and better data. For example, providing natural language interfaces may reduce barriers to providing more guidance to the models making selections. In another example, identifying past similar selections may provide a set of information from which more information about objective functions may be inferred.

An example approach is described below with reference to booking travel selections, but the techniques are not limited to that use case, which is not to suggest that any other feature described herein is limiting. Indeed, these approaches may be used to address any of the above-described example challenges or others like those.

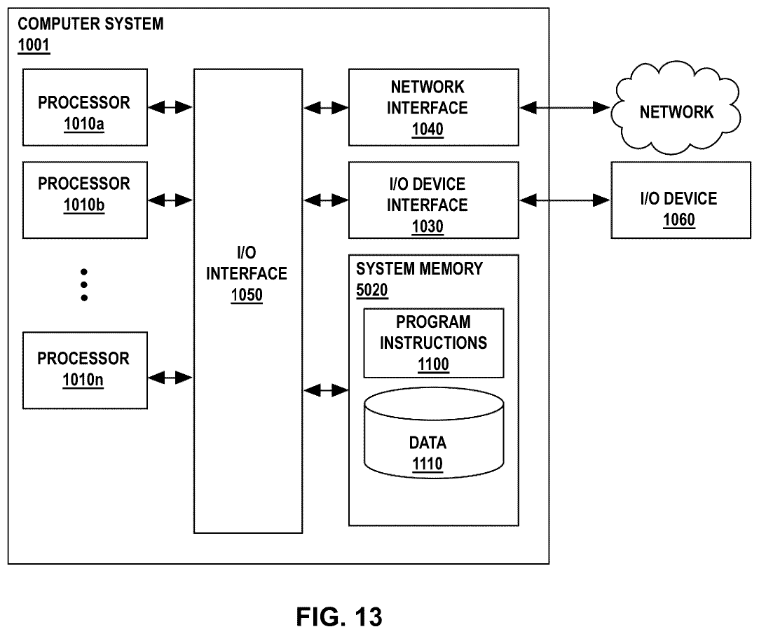

In some embodiments, these approaches may be implemented by a computing system, for instance, a collection of computers like those described below with reference to FIG. 13, communicating with one another over a network like the Internet. Examples include a collection of user computing devices, such as mobile computing devices or desktop computing devices, having browsers or native applications executing thereon, by which users interact with a service hosted by a server system via the Internet that provides the functionality described herein. In some cases, those user computing devices may include a microphone, including integrated into a video recorder, and network interface by which spoken audio is sensed and sent to the server for transcription or transcribed on device.

Corporate travel processes are often designed to facilitate the booking of trips based on a traveler's personal preferences, while also fulfilling relevant operational and financial goals of the organization. These two sets of criteria are sometimes at odds, such as when a traveler is a member of a loyalty program for a provider not included in a corporate list of preferred or in-policy suppliers. In some embodiments, operational and financial goals may include, in addition to traditional budget-spend relative to income or other financial constraints, measures to ensure compliance with supplier contracts, such as meeting a threshold for transactions to access a discount or rebate. It is also worth noting that criteria may change over time, such as when financial goals are adjusted to reflect accelerated spending of a budget allocation or deviations in expected financial performance. Bridging the gap between the two sets of constraints, where one may be driven by user preferences and the other by business criteria, may traditionally require an iterative process (e.g., checking user created itineraries against a set of business rules until the user selects an allowed itinerary), which may prolong the booking experience and negatively impacting productivity.

Chatbots based on large language models (“LLMs”) may be capable of accepting a natural language request, be it oral or textual, and may be capable of being used to book a travel itinerary. However, chatbots (including those based on LLMs) may require more detailed information about the trip to be undertaken than is available (e.g., input or otherwise shared by the user). If or when some of this information is not explicitly included in the request, or is ambiguous, the chatbot may ask the user for the missing details. Once the information is sufficiently complete, the chatbot may use an online booking tool to check possible itineraries (such as by interfacing with application program interfaces for hotel capacity, airline seats, rental cars, restaurant reservation booking, etc.) and may then list the possible itineraries for the traveler to select from.

Such booking tools may make use of previously populated traveler profiles (e.g., for the user, for a traveler the user is booking for, etc.), as well as corporate travel policies, to guide the creation and ranking of itineraries. Herein, “traveler” is used to represent any person or persons for whom the itinerary is created. A user may be the traveler themselves, or another user with permissions to generate, select, and book itineraries for the traveler (such as an entity travel agent, a personal assistant to the traveler, etc.). As used herein, any embodiment described with respect to a “user” may be understood to include application instead or additionally to a traveler even if the user is a different person to whom the traveler has delegated permission for travel booking. Likewise, any embodiments described in reference to a “traveler” may be understood to include application instead or additionally to the user who books the travel, even if different from the traveler. The order of presentation or annotations on the itineraries may reflect these two sets of criteria (for example, “your preferred airport”, “approved rental car provider”, etc.), however the traveler may, in some cases, “game” the booking tool to create a sub-optimal itinerary, e.g., from a corporate perspective, which may create an advantage from the user's perspective. For example, a traveler may select longer flight connection times in order to meet the minimum trip duration for flying business class, as dictated by corporate policy. In other cases, an optimal itinerary from a corporate perspective may be sub-optimal (e.g., unacceptable) from a user's perspective. For example, a redeye flight from Dulles to LAX may be the cheapest option and save an entity the cost of a hotel night in Los Angeles, but may leave an employee too tired to attend meetings. It is expected that some, but certainly not all, non-idealities in itineraries may be constrained by corporate policies, but as travel evolves and due to diverse corporate needs and user preferences, an infinite list of rules is an impractical solution to optimization, such as of travel itineraries.

In order to overcome these drawbacks, which is not to say that embodiments suffering from these issues are disclaimed or disavowed, some embodiments may reduce the need for an explicit traveler profile, where explicit traveler profiles may be static, and instead or additionally reflect a given traveler's utility function (or other objective function) by using details from past trips to implicitly represent the traveler's preferences and calculate the utility function. Traveler preferences may be derived from trips similar (e.g., as determined by proximity of embedding vectors in an embedding space) to others taken in the past, including by the specific traveler or by peers in the organization. The embedding space may have any appropriate size, dimension, embedding method, etc. The embedding space may account for traveler identity, including various traveler characteristics such as business unit, job description, etc. The embedding space may account for travel purposes, such as client (e.g., client identity, client industry, etc.), type of meeting (e.g., business pitch, established client update, fact finding mission, etc.), or other travel motivations. The embedding space may account for location characteristics, including a geographic embedding, time of year, type of location (e.g., urban, suburban, accessible by public transport, etc.), or any other appropriate features. The embedding space may account for additional travel goals, such as “lunch with client”, “personal museum visit”, etc., which may be explicitly included by a user or assumed based on past behavior. If there is a lack of similar trips on which to base creation of a utility function, approximations may be made based on similarity of destination, seasonality, purpose of the trip, or other factors, (where similarity may be determined in the embedding space, including based on some but not all dimensions of an embedding vector or of the embedding space) or by using machine learning models (e.g., as previously discussed) to identify the most determinant (e.g., dominant) among these features for itinerary creation purposes. In this manner, some embodiments may create a self-adjusting profile, tailored not only to the traveler but also to a specific trip being taken. and may keep updating it (e.g., through further self-adjustment) as more trips are taken. In some embodiments, as more trips are taken, a more detailed profile may be generated, including, in some embodiments, splitting of profiles. For example, a user may have a “weekday trip from Austin to San Jose” profile which differs from a “trip from Austin to San Jose which includes a weekend” profile which are created, based on additional information, from an “Austin to San Jose trip” profile. Similar approaches may be used in other domains where heterogeneous, unspecified, or partially specified objective functions are at play, such as those domains previously described.

By using a self-adjusting profile based on previous trips, and by integrating checks against corporate travel policy compliance (or other rules above the user level, such as security rules (for example, passport requirements, visa requirements, etc.), vendor rules (for example, age restrictions on car rentals or rental accommodations, stay length requirements, etc.), some embodiments may increase the likelihood travelers will be presented with and pick an itinerary consistent both with their preferences and within policy, and may thus shorten the time needed to book an itinerary acceptable to both the user and one or more corporate entities.

In some embodiments, such self-adjusting profiles may be used to help resolve ambiguities (e.g., unknowns in the traveler's utility function) without having to rely on the traveler to explicitly supply (e.g., via prompts, in a multiple-turn conversation) all information. By looking at similar trips in the past, some embodiments may be able to fill in missing information to complete the details needed to book a desirable, policy-compliant itinerary. Travelers may appreciate the simplicity of providing fewer details (e.g., fewer than all required details, fewer specifications, reduction of prompts and system (e.g., chatbot) questions), which may increase traveler satisfaction with the booking process. A traveler may resent having to supply the totality of details necessary to generate a profile, including with every booking decision, where travelers may find multiple-turn conversations irritating, which is not to suggest that some embodiments may not include single or multiple turn conversations between a user and the system or process.

This technique, in some embodiments, is referred to herein as “Vox2i” or a “Vox2i Approach.” In some embodiments, “Vox2i” may increase the likelihood that an acceptable travel itinerary is presented to and booked by a user associated with one or more entity, where the entity restricts in at least some way, the user's travel options. In some embodiments, “Vox2i” may be used by a traveler, such as for personal travel, where the user's travel options are restricted only by the user's preferences, such as based on the user's preferences for times, airlines, cost, etc. In some embodiments, “Vox2i” may be used by a traveler where the user's travel options are restricted by one or more entity who provides at least part of the travel itinerary, such as based on hotel stay minimums, rental car drop off location requirements, etc., or by one or more governmental entity, such as based on visa requirements. In some embodiments, “Vox2i” may be used by a traveler where the user's travel options are restricted by an employer, including a contract employer, of the user, or another entity, such as a school, tour group, or other entity which is providing at least partial payment or sponsorship for the user's travel.

In some embodiments, the design and implementation of Vox2i may be characterized by two phases: a preparation phase and a booking phase. The preparation phase and the booking phase may occur asynchronously.

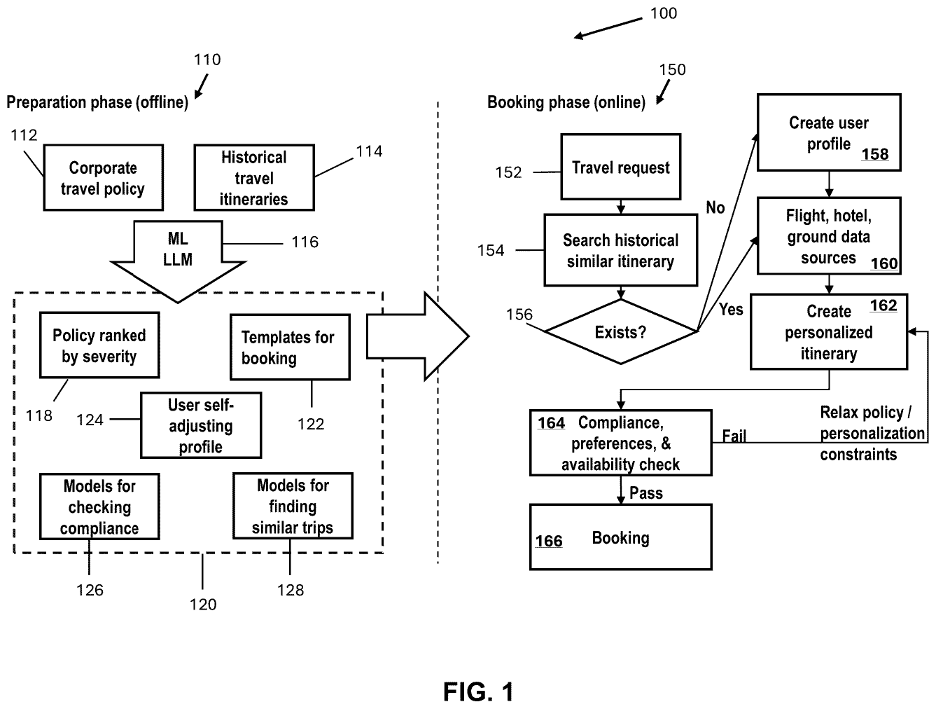

FIG. 1 is a schematic diagram 100 depicting example preparation and booking phases of a process for creation of an itinerary based on natural language processing, in accordance with some embodiments. FIG. 100 depicts preparation phase 110, which may be executed at any appropriate time prior to booking phase 150, including based on a request for booking which may trigger implementation of the preparation phase 110 for a user for whom the preparation phase may not have been previously performed or updated.

In some embodiments, the preparation phase 110 may be executed once (e.g., substantially once), including during an onboarding operation (e.g., for the deployment of Vox2i for an entity, at an employee's onboarding to such an entity, etc.), including prior to deployment (e.g., a first deployment of Vox2i or of Vox2i for a given user). In some embodiments, the preparation phase 110 may occur periodically, included as an update to an initial preparation phase (e.g., at first deployment), as a rebuild or replacement of a previous preparation phase, etc. The preparation phase 110 may occur asynchronously to the booking phase 150, asynchronously to user travel, etc. The preparation phase 110 may be triggered by updates to any appropriate database, including those databases on which it is in communication. The preparation phase 110 may occur offline, wherein “offline” may mean within an entity's computer system or network, but without communication with one or more booking platform or user input method or system. The preparation phase 110 may, in some embodiments, occur online, such as in a Vox2i system in communication with one or more database. “Offline” as described in reference to the preparation phase 110 may mean that the preparation phase 110 may not interact directly with the user or travel itinerary generation systems or processes, not that the preparation phase 110 (or Vox2i in the preparation phase 110) is isolated from a network (e.g., or the internet). In some embodiments, the preparation phase 110 and the booking phase 150 may occur substantially concurrently, simultaneously, or sequentially, and the preparation phase 110 may be in communication, including through Vox2i in the booking phase 150, with one or more online entity.

In some embodiments, during the preparation phase 110, Vox2i may generate policy models and traveler profiles based on travel policy documents (e.g., based on corporate travel policy 112) and historical data from itineraries traveled (e.g., historical travel itineraries 114). The corporate travel policy 112 may be retrieved from any appropriate database or location, including a database within the Vox2i system. The corporate travel policy 112 may be saved as a set of rules. The corporate travel policy may be saved as a document or in a database which may be queried, including during retrieval-augmented generation (RAG). The historical travel itineraries 114 may be retrieved from any appropriate database or location, including a database within the Vox2i system. The historical travel itineraries 114 may be tagged or otherwise associated based on various features, including traveler, travel location, purpose, or any other feature of travel identified herein. In some embodiments, the historical travel itineraries 114 may be tagged based on various features by a LLM or any other appropriate method, including manually such as during onboarding, based on database categories, etc. In some embodiments, the preparation phase 110 may include, for example, a dialog of guided questions or form filling during a new traveler's onboarding (e.g., to a company, to Vox2i, etc.), to seed their initial profile, including before they have booked any itineraries. In some embodiments, a model 116, which may be a machine-learning (ML) model, including an LLM, may ingest information (such as from the corporate travel policy 112 and the historical travel itineraries 114) to generate a set of designs 120 for use during the booking phase 150. The set of designs 120 may include one or more profiles, templates, models, etc., which may be callable objects or any other appropriate fillable, including pre-populated such as for a user profile 124 (e.g., a user self-adjusting profile), or with one or more empty data receptacles, such as for a booking template 122. For example, the set of designs 120 may include a ranking of policy severity (e.g., policy ranked by severity 118) for the corporate travel policy 112. In some embodiments, this may determine which policies may be preferentially violated (for example, to comply with a higher-ranked policy, a lower-ranked policy may be violated), for which policies an exception may be requested, granted, etc., or any other policy nuances. The set of designs 120 may include one or more templates for booking (e.g., the booking templates 122), which may be populated in the booking phase 150. The booking templates 122 may be any appropriate template, including a standardized template for all users or a dynamic template, such as one customized per user, per destination, per travel type, etc. The set of designs 120 may include one or more user profile 124, which may be a self-adjusting user profile, including a user profile which adjusts based on receipt of a historical travel itinerary (e.g., in historical travel itineraries 114) associated with the user or at any other appropriate time, such as when the preparation phase 110 is initialized or populated. The user profile 124 may have one or more empty data containers. For example, the user profile 124 for a first user may not include any preferred hotel chains. In another example, the user profile 124 for a second user may include an inferred preferred hotel chain, based on previous hotel stays. In some embodiments, a level of confidence for a user preference or other object contained in the user profile 124 may be provided. For example, a preferred hotel chain may be marked as high confidence (for example, if the user has indicated a preference, including in response to a prompt), medium confidence (for example, if the user has stayed at the hotel chain before), or even low confidence (for example, if the preferred in inferred based on other users similar to the given user). In some embodiments, the source of a user preference or other object in the user profile 124 may be indicated, such as by a pointing vector, a tag, etc.

The set of designs 120 may include one or more models for checking compliance 126. The models for checking compliance 126 may be any appropriate models, including rule-based models. The models for checking compliance 126 may be created (for example, trained) in the preparation phase 110 and deployed (or otherwise used) in the booking phase 150. Input to the models for checking compliance may be corporate travel policy 112. In some embodiments, the models for checking compliance may also or instead be trained on historical travel itineraries 114 or other examples of compliant travel itineraries. The set of designs 120 may include one or more models for finding similar trips 128. The models for finding similar trips 128 may be any appropriate models. The models for finding similar trips 128 may operate on embeddings corresponding to itineraries, such as those in embedding spaces and embedding vectors as previously described, including by generating embeddings (e.g., with an embedding layer) from one or more travel itinerary. The models for finding similar trips 128 may be created based on the historical travel itineraries 114, with or without user profiles corresponding to such historical travel itineraries. The models for finding similar trips 128 may be used to generate one or more user profiles 124, which may be or be used to generate self-adjusting user profiles. The models for finding similar trips 128 may operate on input from the models for checking compliance 126, including as an ensemble of models. In some embodiments, historical travel data (e.g., the historical travel itineraries 114) may be used during the preparation phase 110, to create one or more models for characterizing travel by a specific individual to a given destination (e.g., John Doe is traveling to Portland, OR), which may be referred to as Traveler-Destination Pairs (TDPs). TDPs, in some embodiments, may be generated when the traveler booking an itinerary is visiting the destination for the first time, may be used to derive a set of preferences using existing itineraries (e.g., from other TDPs associated with the traveler or with other travelers to the destination), and may provide key data features for generation of a new traveler-destination pair. These preferences may be used to create the user profile 124 or a TDP within the user profile 124, to specify a TDP (e.g., to locate a TDP with a user profile 124, such as to determine whether it already exists, or is it seen for the first time, in which case a new TDP may be generated in the user profile 124).

In some embodiments, the user profile 124 (which may be a self-adjusting user profile) may be extracted, such as by one or more machine learning algorithms, which may operate to filter and collect the user preferences, including from historical travel itineraries 114. In some embodiments, a model may operate on two or more categories, which may include a user-specific preferences model (e.g., which operates on data associated with a single user), and a group-wide preferences model (e.g., which operates on data associated with a set of travelers with similar profiles). In some embodiments, the group-wide preferences model may be, instead or additionally, a set of models based on preferences of different groups and sub-groups. For example, one group-wide preference model may operate based on all entity-related travelers, while another group-wide preference model may operate based on consultants based in Dallas. In some embodiments, historical travel itineraries 114 corresponding to a single user may be used by multiple group-wide preference models with different scope.

In some embodiments, the booking phase 150 of Vox2i may occur “online”, that is, in communication with one or more external travel itinerary generation or booking instrument, such as an API, website, application, etc. The booking phase 150 may be initiated by a user, such as when the user (e.g., traveler) determines that a travel itinerary is required and initiates a login into (or other contact with) a booking system of Vox2i. The booking phase 150 may include a travel request 152, which may be information supplied by the user for generation of the travel itinerary. Submission of the travel request 152 may cause Vox2i to search for a similar itinerary, such as from the historical travel itinerary 114 of the preparation phase 110, such as at operation 154. In some embodiments, submission of the travel request 152 may prompt Vox2i to search for a user profile 124 (e.g., as created in the preparation phase 110), which may in turn contain similar travel itineraries of the user or another similar user or similar group of users. In some embodiments, if information about similar itineraries is found (such as is determined to exist at operation 156), then a new travel itinerary may be generated, such as based on the user profile 124 (at operation 160). If information about similar itineraries is not found (such as not determined to exist at operation 156), then a user profile 124 may be generated (e.g., at operation 158), including based on similar users, based on a group-wide preferences model, etc. Once a user profile 124 is identified (or created), Vox2i (e.g., in the booking phase 150) may use the user profile 124 in combination with an online or other external agent to locate and query flight, hotel, ground transportation, and other travel itinerary generation and booking services (e.g., at the operation 160). The operation 160 may include any appropriate data retrieval operation, including through one or more API, chatbot, entity-specific application, browser, etc. Based on data retrieved in the operation 160 and the user profile, a personalized itinerary may be generated at operation 162. Vox2i may then (or may concurrently) check the personalized itinerary against corporate travel policy 112 or other compliance requirements, preference (e.g., as identified in the user profile 124), and availability (where availability may be determined at operation 160 where travel sources may be queries about both travel options and their availability) at an operation 164. If the itinerary passes the one or more checks, the itinerary may be booked at an operation 166 (or provided to a user for a final approval to book). If the itinerary fails the check, one or more restrictions or user preference (e.g., of the user profile 124) may be relaxed in order to generate an updated personalized itinerary at the operation 164, which may be checked iteratively until the personalized itinerary passes the one or more checks or there are no more available personalized itineraries to check against the one or more restrictions.

A variety of techniques may be used to build an itinerary. In some embodiments, itinerary construction may be formulated as a weighted constraint satisfaction problem over a typed and bounded discrete state space. Each candidate solution state may be defined by a vector of decision variables corresponding to component-level itinerary choices, including but not limited to outbound and return transportation legs, hotel bookings, ground transfer segments, and appointment or meeting time slots. Each decision variable may have a finite domain derived from external supplier catalogs or internal scheduling windows. The feasibility of a candidate state may be gated by a combination of hard constraints, soft constraints, and default assumptions encoded as commonsense constraints. Hard constraints may include travel document requirements, policy budget ceilings, minimum layover durations, and supplier inventory rules. Soft constraints may encode personal preferences, travel cohort alignment, or loyalty program participation, while commonsense constraints may include learned behavioral defaults weighted by confidence scores derived from prior travel patterns.

Each state may be represented compactly by a combination of a binary rule atom vector and a numerical cost vector. The binary vector may encode satisfaction or violation status for a precompiled set of constraint atoms, allowing a mask of between 64 and 512 bits to track rule compliance efficiently. The associated cost vector may comprise fixed-length tuples (c_policy, c_pref, c_contract, c_time, . . . ), with each component reflecting the aggregate penalty for a corresponding objective. For example, c_policy may quantify the severity of policy violations, c_pref may quantify distance from stated or inferred user preferences, and c_time may reflect inefficiencies in the temporal layout such as excessive idle periods or late arrivals.

Constraint evaluation may be structured to support high-throughput filtering and incremental recomputation. In some embodiments, hard policy logic and supplier eligibility rules may be compiled into directed acyclic graphs (DAGs) or reduced ordered binary decision diagrams (BDDs), affording fast traversal and outcome evaluation in time proportional to the subgraph depth. Time window constraints, including blackout periods and appointment overlap conditions, may be encoded using interval trees or segment trees to support logarithmic-time updates and queries. Global constraints such as all-different and no-overlap may be stored with incremental propagators that react to partial assignments. To support efficient incremental constraint evaluation, in some embodiments, each rule atom may be indexed to its associated decision variables, enabling selective reevaluation when a particular component is altered. Evaluation results for rule atoms may be memoized in a cache keyed by (component_id, rule_version), reducing recomputation overhead during iterative search.

The search process for feasible and high-quality itineraries may combine exact and heuristic techniques in a staged approach. An initial assignment may be computed using constraint programming or integer linear programming over a reduced skeleton of variables, such as overall time constraints, city sequence, or number of nights. This skeleton may then be refined via branch-and-bound search over the remaining component decisions. In some embodiments, lexicographic optimization may be used to prioritize objectives, minimizing the policy cost component before considering contract cost, preference cost, or temporal inefficiencies. A Pareto frontier of non-dominated partial solutions may be maintained in a balanced tree indexed by cost vectors; as new nodes are expanded, dominated states may be discarded to limit combinatorial explosion. When conflicting objectives exhibit tight tradeoffs, an ε-constraint approach may be applied: the search may fix an incumbent minimum for the primary objective (e.g., c_policy) and iteratively tighten bounds on secondary objectives (e.g., c_contract, c_time) to discover a set of K diverse solutions that respect primary constraints.

Search guidance may be improved by learned heuristics. In some embodiments, a value function V(s) may be trained to estimate the residual penalty or suboptimality of a partial state s. A search heuristic such as Weighted A* may be employed, with the cost function f(s) defined as the sum of accumulated cost g(s) and a weighted future cost α·V(s). Decision variable branching may follow a fixed or adaptive order derived from offline learning of variable impact scores; for instance, the search may prioritize hotel selection over return leg selection when historical data indicates that hotel location strongly influences feasible return options. Coupling constraints across components (such as carrier consistency for multi-leg trips to trigger negotiated rates) may be handled via Lagrangian relaxation. Lagrangian multipliers associated with such constraints may be propagated into local scoring functions for affected components, affording faster convergence than iterative reranking of global assignments.

Feasibility checking for partial or complete states may be implemented to achieve constant or logarithmic time updates. Rule mask updates may be limited to the bits affected by the most recent variable assignment, and cost deltas may be updated incrementally using local caches. Time-based feasibility queries may be resolved in O(log n) time via interval tree lookups. Evaluation of policy DAGs may scale with the depth of the affected portion of the graph rather than the total number of constraints. To generate a small, high-quality, and diverse output set, a ranked beam of K candidate itineraries may be maintained using Determinantal Point Processes or Maximal Marginal Relevance methods, incorporating both cost vector diversity and embedding similarity to avoid near-duplicate solutions. In some embodiments, similarity may be computed over latent embeddings derived from component sequences, supplier types, or cost profile patterns, allowing a balance between objective quality and output variety.

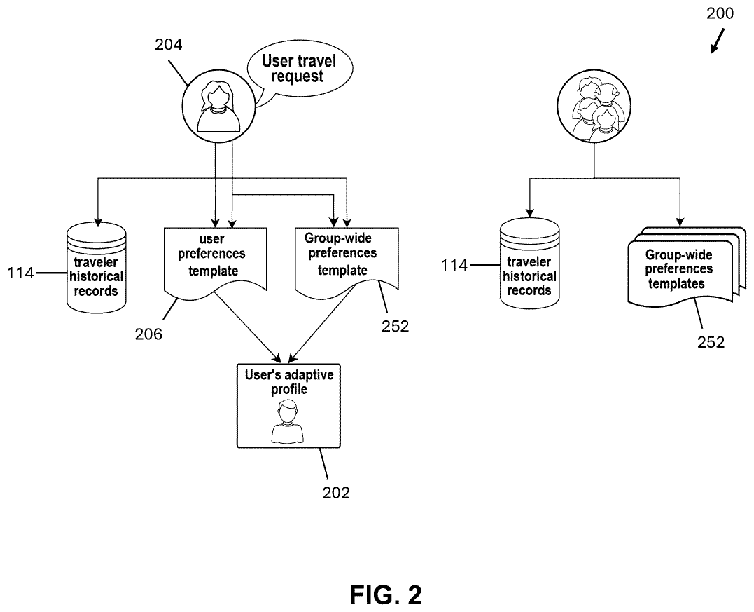

FIG. 2 is a schematic diagram 200 depicting an example user profile 202 and a set of group wide preferences 252 for similar travelers, in accordance with some embodiments. In some embodiments, the user profile 202 (which may be the user profile 124 of FIG. 1) may be generated based on identification of the user's preferences (e.g., from a user preference template 206 based on the given user) or based on identification of preferences of users similar in at least some way to the user (e.g., from a group-wide preference template 252 based on a group of users). In some embodiments, the user profile 202 may be an adaptive profile. In some embodiments, the user profile 202 may operate to provide personalized results for the user, including based on preferences of the user or of a group of users, which may or may not include the given user. In some embodiments, the user profile 202 may filter out information irrelevant to the user, or simply not include such information in the user profile 202. In this manner, the user profile 202 may provide a smaller, more quickly accessible template (e.g., smaller than searching all previous user itineraries) that may facilitate booking of successful travel itineraries.

In some embodiments, an adaptive profile may be assembled by identifying the user's own preferences (if any), and a set of group-wide preferences from similar travelers. In some embodiments, to meet such a goal, the model may update users' preferences to build the most up-to-date preference model for each user. Such updates may be relatively constant—that is, may occur on a faster time cycle than travel is booked so that the user profile may be assumed to be updated for any next travel itinerary generation—which is not to require that such updates be instantaneous. For example, updates may occur hourly, daily, weekly, etc. Updates to a user profile may be implemented by pushing of updates, such as after a new travel itinerary is booked or otherwise uploaded to the Vox2i system. Updates to a user profile may be implemented by pulling of new information, such as periodically by the Vox2i system retrieving any new travel itineraries from a repository. The user preference updating may be implemented by using one or more classifiers (such as in a classifier method of module, which may use any appropriate classifier (or comparator) method, such as K-nearest neighbors (KNN), logistical regression, etc.) which may take as input the historical data of a single user and outputs the user's preferences. In some embodiments, the input of historical data from multiple users may be used to approximate a user's preferences, where the given user (whose preferences are approximated) may or may not be included in the multiple users whose historical data is used. In some embodiments, for example, in the case of cold-start users (or where no historical data is found for the given user) a user preference model may be implemented by applying clustering methods (which may be any appropriate cluster or grouping method or module, such as a k-means clustering, hierarchical clustering, etc.) to perform the steps including: using the user profiles of all users, identify groups of users with similar profile information, including by clustering; collecting the historical data of all users belonging to the same group; identifying, by a classifier, group-level preferences; and identifying, including by the same or a different clustering method, the group to which a given user belongs and creating, as the given user's initial profile, a profile based on the group level preference. In some embodiments, such group-level preferences may be used as the given user's preferences until the system collects enough historical data about the user to build its own profile. Examples of which are described in Sabet, A. J., Shekari, M., Guan, C., Rossi, M., Schreiber, F., & Tanca, L. (2022). THOR: A hybrid recommender system for the personalized travel experience. Big Data and Cognitive Computing, 6(4), 131. DOI: 10.3390/bdcc6040131, the contents of which are hereby incorporated by reference.

In some embodiments, itinerary templates may be represented as parameterized, typed directed acyclic graphs (DAGs), where each node corresponds to a component role such as an outbound flight segment, a hotel night stay over a time interval, a ground transfer instance, or an activity block, each associated with type constraints, parameter schemas, and local preconditions and postconditions. Edges in the graph may encode temporal, spatial, or resource-based dependencies, including sequencing requirements (e.g., flight arrival before hotel check-in), co-location constraints, or conditional dependencies (e.g., transfer required if distance exceeds a threshold). Templates may be stored in a versioned library, where each template entry includes a role-level schema validator similar to a JSON Schema, an attribute grammar that may synthesize valid instantiations from abstract user intents or semantic queries, and a compact constraint signature bitset indicating which constraint atoms from the broader rule universe are relevant to that template.

Template selection may proceed via a two-stage filtering and ranking pipeline. In a first stage, symbolic filtering may be performed by intersecting a request signature (determined from request metadata, user profile attributes, and policy constraints) with stored template constraint signatures. This intersection may serve to eliminate templates that contain structurally incompatible components or violate obvious constraints (e.g., if the user profile mandates no air travel, templates with mandatory flight roles may be excluded). Meta-level heuristic rules may also be applied at this stage, such as verifying that a multi-city request corresponds to a template with at least two air segments and inter-city transfer dependencies. In a second stage, the surviving candidate templates may be ranked using a learned classifier that scores compatibility based on extracted features, which may include named entities and time expressions in the request, group size and cohort signals from the user profile, and policy context metrics such as rigidity indices. The system may return the top-K scoring templates for downstream instantiation to support diversity in candidate generation.

Decomposition of a selected template into smaller, more tractable sub-itinerary problems may be achieved by identifying weakly coupled regions within the component dependency structure. To do this, a hypergraph may be constructed from the template DAG, where hyperedges capture multi-node constraints such as same-carrier requirements across multiple flights or spatial proximity constraints across hotel and arrival segments. A minimum-cut algorithm may be applied to this hypergraph to identify a partition that minimizes the severing of high-weight constraints, thereby yielding a set of sub-itinerary components such as air travel, lodging, and local transportation blocks. Each block may then be solved independently using dedicated catalogs and propagators aligned with the corresponding component type. After local solving, sub-itineraries may be reconciled at their interfaces using a constraint join operator that enforces alignment of shared variables such as arrival times, location codes, or transfer availability. In cases where reconciliation fails, the solver may backjump to the minimal subset of components responsible for the inconsistency, rather than restarting the full decomposition, thereby reducing redundant recomputation.

During itinerary assembly, a global timeline structure may be used to represent the overall itinerary schedule. In some embodiments, this timeline may be implemented as a balanced interval tree to allow O(log n) insertion, removal, and feasibility queries. The tree may track occupied and unoccupied time intervals along with associated gap constraints, such as minimum connection times or maximum layover tolerances. As components are inserted in the order defined by a topological traversal of the template DAG, global constraints such as no-overlap and minimum-connection may be enforced in some embodiments. Each interval in the tree may store a small fact table of satisfied eligibility predicates to prevent re-evaluation of redundant or upstream rule checks.

To generate a set of diverse candidate itineraries efficiently, in some embodiments, the system may apply iterative deepening search with bounded discrepancy from a greedy baseline. This may allow near-optimal variations to be explored without fully enumerating the search space. Partial instantiations may be cached using composite keys such as (template_id, city_sequence, time_buckets) to allow reuse across similar requests. To enforce diversity in the output set, constraints may be applied on the Hamming distance between component ID sequences, or determinantal point processes (DPPs) may be used to select itinerary embeddings that maximize overall coverage in the feature space. Embeddings may be derived from component types, sequence patterns, and cost vectors, and may reflect structural and semantic similarity. Each emitted candidate may include metadata reflecting provenance, including the constraint rules and template edges that contributed to each inclusion decision, which may later support incremental updates when constraints or inputs change.

Supporting infrastructure may include precomputed per-template “hot paths” (e.g., frequently used subgraphs specific to cohort behavior), which may be stored as macro expansions for efficient instantiation. Supplier catalogs may be indexed by multiple dimensions, such as city, time bucket, and fare class, in read-optimized formats with delta logs to support low-latency updates. Some or all evaluations involving policies or rule logic may include version identifiers to ensure reproducibility and to allow memoized results to be reused only when the rule versions match, in some embodiments.

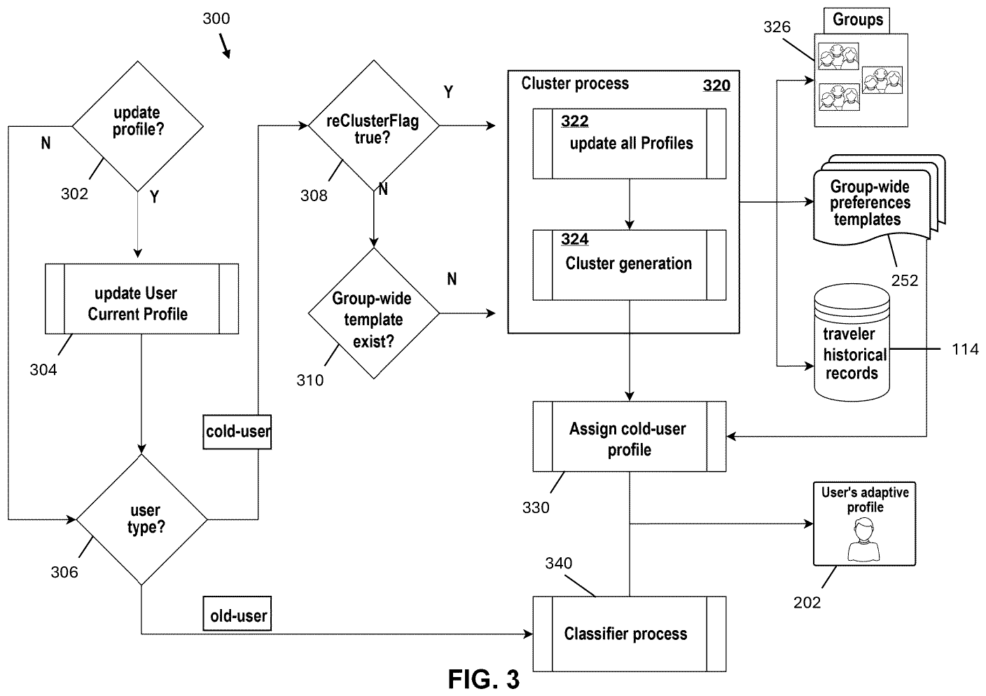

FIG. 3 is a schematic flowchart 300 depicting an example workflow to create and update a user profile, in accordance with some embodiments. FIG. 3 depicts a workflow to create and update a user's adaptive profile. The workflow of FIG. 3 is based on two main mechanisms: clustering and classifying, which is not to say that some operations described in relation to clustering may not instead be performed by a classifier or another operation nor that some operations described in relation to classifying may not instead be performed by a clusterer or another operation.

As depicted in flowchart 300, a user profile (e.g., the user profile 124 of FIG. 1, the user's adaptive profile 202 of FIG. 2, etc.), may be accessed by the system of Vox2i. When the user profile is accessed, or at any other appropriate time when the user profile is selected, flagged, etc. for updating, a determination (such as at operation 302) may be made as to whether the user's profile is to be updated. For example, at the operation 302, the user profile may have its age (e.g., time of last update) determined, and user profiles older than a threshold may be refreshed while user profiles newer than the threshold may not be refreshed. In another example, the user profile may be selected for updating based on receipt of historical itinerary data corresponding to the user, a group to which the user belongs, etc. If the user profile is to be updated, Vox2i may update the user profile, such as based on any appropriate data, model, etc. as previously described, at operation 304. If the user profile is not to be updated, flow may continue to operation 306, where a user type may be determined. During the operation 306, Vox2i may determine if the user is a previous user (e.g., an “old user”) or a new user (e.g., a “cold-user” or other user for which the system cannot access a user profile). In the case of a new user, flow may continue to operation 308, where it may be determined whether or not identify a group to which the new user may belong. For example, at the operation 308, a re-clustering, such as by a clustering model as previously described, may be triggered by one or more flags (e.g., on the user profile, on a group membership, etc.). Further, a cluster process may be triggered at an operation 310, even if the user profile is not tagged for re-clustering, because of the presence or absence of one or more group wide template. For example, a user may be identified as belonging to a group in the operation 308, but if that group does not have a group-wide template accessible by Vox2i, a cluster process 320 may be triggered. The cluster process 320 may include updating of user profiles (e.g., all user profiles, a subset of user profiles, user profiles for members of a selected group, etc.), such as an operation 322. In some embodiments, the cluster process 320 may generate new or different (e.g., different than previously clustering groups, such as more granular, with different sets of users, etc.) clusters or groups of users, TDPs, etc. The user's profile may then be updated based on characteristics of the groups (e.g., groups 326) to which the user belongs, such as group-wide preference templates (e.g., the group-wide preference templates 252 of FIG. 2), historical travel itineraries (e.g., the historical travel itineraries 114 of FIG. 1), or by any other appropriate method such as those previously described. In some embodiments, after cluster generation, a new user profile may be assigned to one or more groups of users (e.g., clusters). In some embodiments, for a previous user (e.g., a user with a user profile or a user for a system where clusters or groups of users already exist), a classifier process may be triggered, such as at an operation 340. In some embodiments, both a cluster process and a classifier process may be triggered, including for the same or different users concurrently, subsequently, simultaneously, etc. The user's adaptive profile (e.g. the user's adaptive profile 202 of FIG. 2) may then be created, updated, etc., based on any applicable cluster process, classifier process, or combination thereof.

Because the creation of itineraries by Vox2i (e.g., in the booking phase such as depicted in the booking phase 150 of FIG. 1) may use historical information and examination of candidate itineraries, in some embodiments, two (or more or less) tools may be created during a phase (e.g., in the preparation phase such as depicted in the preparation phase 110 of FIG. 1) to check for policy compliance and affinity to a traveler's preferences, while also accounting for possible changes in the former and the dynamic nature of the latter. These tools are described and depicted as two separate tools herein for case of description only but instead may be one tool or divided into a larger multiplicity of tools.

For the policy compliance tool, in some embodiments, a set of itinerary templates may be created based on traveler's historical data, including by filtering historical travel itineraries of the user such that only those itineraries that are in compliance with current travel policies are included for template generation. In some embodiments, additional filters may be used, such as lookback window filters, which may exclude, for template creation, user travel itineraries older than a threshold, such as five years, two years, etc. These itinerary templates may then be represented using a scripting language (for example, in JSON), where the itinerary templates may include containers for data corresponding to fundamental pieces of each travel itinerary, such as advanced-booking requirements, air, train, and hotel reservations, the use of other transportation, type and class of service, on-site spending limit, the strictness of each policy rule, processes for obtaining an exception (if any), etc. In some embodiments, data containers may require input in order for a travel itinerary to be generated from a template. In some embodiments, data containers may accept a null input or be otherwise left empty and still function for travel itinerary generation. For example, for a template describing train travel, a data container corresponding to “airline name” may be left blank, accept a null value, or even be deleted from the template.

Travel policies may not be static; they may change periodically, including driven by financial results, general business performance, personnel changes, etc. For example, business mandated reductions in travel budgets, or outright travel restrictions, may be among the first actions applied to reign in discretionary spending. In other instances, accelerated spending (e.g., an increase in the rate of spending) of travel budget allocations may trigger restrictions, or activate policies to reduce travel costs, such as limiting the use of premium classes of service in air travel. The changes may be temporary in nature and may reset at the end of an accounting period, such as a financial reporting quarter, (fiscal) year-end, monthly, etc. Other changes may be more permanent or have phase-in or phase-out periods. In some embodiments, dynamic policy changes may be accounted for within an itinerary template format.

In order to account for changes in travel policy, which may be periodic, cyclical, resetting, etc., in some embodiments, travel policies and travel templates may be broken down into various categories. For example, various categories may be identified among the travel policies which sort the travel policies by endurance of the travel policies, for example, policies which are static or otherwise enduring, policies which may be temporary (including with information about their expected application period), etc. Associated templates may then be identified (e.g., tagged or otherwise associated) with the categories of travel policies to which they correspond. The identification of endurance categories in policy templates may be used to assist in a booking process, such as by accounting for both fixed and temporary policies. Therefore, in some embodiments, itinerary templates may be categorized according to different scenarios (including travel policy category). In some embodiments, itinerary templates may be (also or instead) associated with a variety of selectable options. For example, itinerary templates may be categorized based on employee's roles (e.g., traveler role), type or class of services, budget limitations, etc.

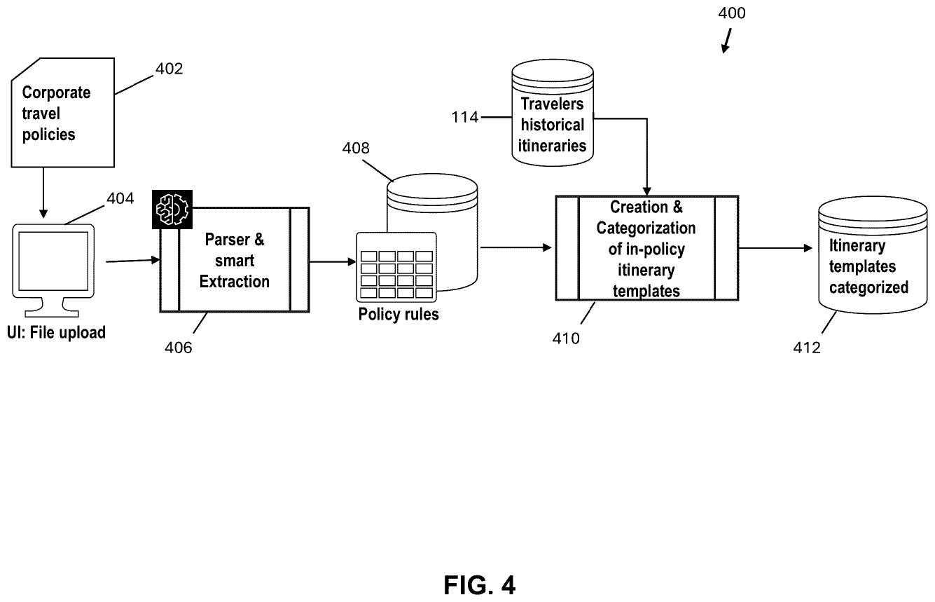

FIG. 4 is a schematic diagram flowchart 400 depicting an example workflow for creating itinerary templates based on policy rules, in accordance with some embodiments. Flowchart 400 shows steps in the workflow from ingesting policy rules (e.g., corporate travel policies 402) to the creation and categorization of different itinerary templates (e.g., categorized itinerary templates 412), where categories for the itinerary templates may include temporal and other categories, including categories specific to a business domain or dictionary. In some embodiments, if there is no labeled data, the categorization of the itinerary templates may be performed by a clustering process (for example, K-means), which may be used to discover the desired patterns or groupings.

As shown in flowchart 400, corporate travel policies 402 may be obtained from any appropriate source and in an appropriate format and uploaded (e.g., at operation 404) into the Vox2i system. The upload may occur through a user interface (UI) specific to an application of Vox2i, through a browser interface, or any other appropriate input method or system. Once Vox2i has access to the corporate travel policies 402, they may be parsed and rules extracted, such as by parser 406. The parser 406 may generate a set of policy rules 408, which may include policy rule exceptions or any other appropriate characteristics as previously described. Based on the policy rules, which may include a determination based on the current policy rules, based on policy rules for a time period (e.g., for fiscal year 2026, which may be a time period in the future or even in the past), etc., various itinerary templates may be characterized, including as “in-policy” and “out-of-policy” or by any other appropriate categorization (e.g., “in-policy for 2026,” “in-policy for austerity measures,” “out-of-policy for executive travel for client B,” etc.) which may be binary or multi-level.

In some embodiments, such as during the booking phase (e.g., the booking phase 150 as described in relation to FIG. 1), a classifier process (for example, KNN) may be used to find the options (e.g., of the itinerary templates) matching a company's dynamic policy (for example, the current policies in effect, or the policies predicted to be in effect at the time of travel, etc.). In some embodiments, the user may provide some constraints on the budget, the class of service, etc., and the classifier process or other processes of Vox2i may then select those itineraries categorized as meeting such constraints.

In some embodiments, the historical information containing previous itineraries or other features of travelers may be used to build machine learning models to produce vector representations or embeddings (e.g., such as in any appropriate embedding space as previously describe), which may be used together with embeddings of candidate itineraries (e.g., of any appropriate vector size, including embeddings which may correspond to components of travel itineraries or the full itineraries themselves) to measure affinity (e.g., similarity) and narrow down itineraries or itinerary templates a traveler may prefer from a set of all candidates travel itineraries that satisfy bounds created by, for example, hard policy or preference constraints.

In some embodiments, handling multiple objectives, which are likely to occur in real-world travel scenarios, may be considered to be a multi-dimensional constraint problem. These constraints may be categorized as: hard constraints, soft constraints, and commonsense constraints, or any other appropriate constraint categories. Hard constraints may be explicitly set by the user and may be scenario-specific (e.g., departure and return date). Hard constraints may also include constraints set by policy (e.g., spending limits), which may be required to be strictly followed. Hard constraints may include any nonnegotiable elements of travel. Soft constraints may be constraints (e.g., preferences) related to a user (e.g., a specific traveler) but valid across multiple scenarios. Soft constraints may be discovered from historical itinerary data. In some embodiments, soft constraint preferences may be uncovered continually, including gradually, piece-wise, etc., including by using one or more machine learning models accessing historical itineraries across multiple scenarios for a traveler. Such soft constraints may evolve over time, including based on further user interactions. Soft constraints may also include policies which are guidelines rather than hard limits, such as preferred rental car vendor, or other policies which may otherwise be violated by itineraries, such as if no other options exist. Commonsense constraints may be based on general knowledge (e.g., human knowledge, machine knowledge, etc.) applicable to various scenarios. Commonsense constraints may be extracted from historical data, provided by users (e.g., provided as user feedback, such as “30 minutes it too short a time to make a connection at DFW”), hard-coded (e.g., as a list of rules), etc. For example, common-sense data may be generated by a LLM, or any other appropriate generative model, and may include constraints on traveler situations which have not yet occurred or are not present in the training data (e.g., the historical travel itineraries) accessible to Vox2i (e.g., a city bus in not appropriate ground transportation when the traveler is accompanied by a baby), and may be continually adjusted with user interactions. Examples of which are described in Xie, J., Zhang, K., Chen, J., Lou, R., Su, Y. (2024) TravelPlanner: A Benchmark for Real-World Planning with Language Agents. International Conference on Machine Learning. https://arxiv.org/abs/2402.01622, the contents of which are hereby incorporated by reference.

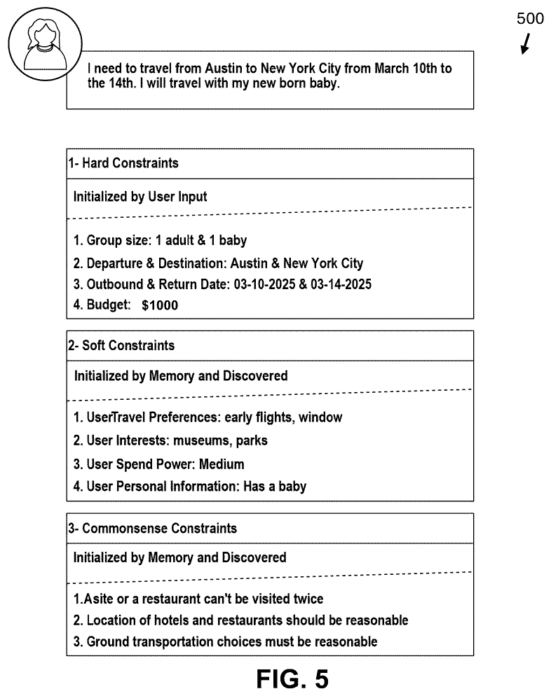

FIG. 5 is a schematic diagram 500 depicting an example of constraint identification and generation, in accordance with some embodiments. The various hard constraints include constraints initialized by the user, such as group size, departure location, destination location, travel dates and duration, budget, etc., but may also or instead include any appropriate limits, such as those previously described. The various soft constraints include constraints discovered from previous user itineraries, such as personal travel preferences, interests, spending level, personal information (including about other people in the traveler's group), but may also include information discovered about similar users, such as based on a group to which the given user belongs. The various commonsense constraints may include reasonableness constraints on itinerary locations, pricing, visit duration, number of visits, etc. For example, for a user identified as a wheelchair user, handicap accessibility may be considered. These constraints may serve to narrow down the potentially infinite space of available travel itineraries to those most likely to be acceptable to the user. These constraints may be those applied to and by the user, and other constraints applied to and by an entity sponsoring the travel or providing one or more elements of the itinerary (e.g., a hotel minimum stay), etc.

In some embodiments, including in addition to the above constraints, knowledge augmentation may be performed, including based on a user's preferences as reflected by previous itineraries, and may enhance the likelihood of providing an acceptable itinerary and, also or instead, facilitate the search for matching itineraries, such as during the booking phase (e.g., the booking phase 150 of FIG. 1) of Vox2i.

In some embodiments, knowledge augmentation may involve one or more entities (e.g., ML models, datastores, logs storing previous searches, chatbot prompts, etc.) that may enable a knowledge-centric light-weight personalization (for example, London visited five times, Hilton three times, Enterprise-rent four times). In knowledge augmentation, such data may be created in a first step and then retrieved from a personal preferences store when needed, such as during a booking phase. The personal preferences store may be built over time by aggregating entries (e.g., vendors, airports, travel companions, etc.) that appear in the user's previous itineraries. Knowledge augmentation may be further enhanced by presenting (e.g., offering) multiple views which may include both the entries (e.g., vendors, airports, travel companions, etc.) the user may be familiar and those unfamiliar with, which may include reminding a user about entities they previously interacted with and may have forgotten about (for example, “Have you considered flying out of Reagan airport instead of Dulles? You used to prefer Reagan”). Examples of which are described in Back, J., Chandrasekaran, N., Cucerzan, S., Herring, A., and Jauhar, S. K. (2024). Knowledge-Augmented Large Language Models for Personalized Contextual Query Suggestion (K-LAMP). In Proceedings of the ACM Web Conference 2024 (WWW '24). Association for Computing Machinery, 3355-3366. https://dl.acm.org/doi/10.1145/3589334.3645404, the contents of which is hereby incorporated by reference.

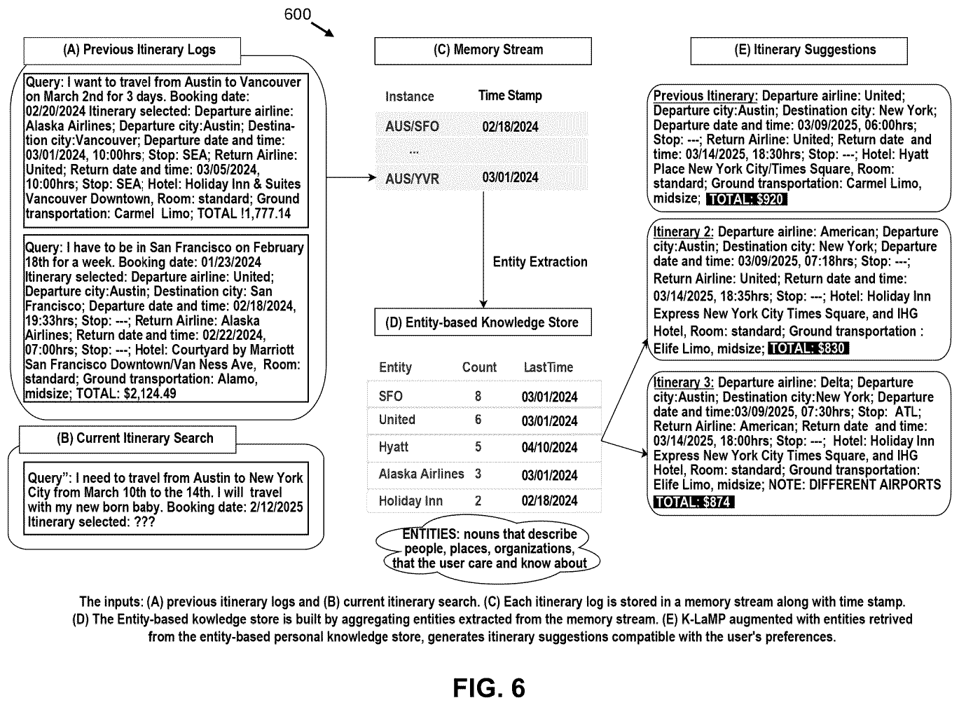

FIG. 6 is a schematic diagram 600 depicting a knowledge-augmented model for itinerary creation, in accordance with some embodiments. Knowledge augmentation, in this example, may be based on previous itinerary logs, a current itinerary search, a memory stream, or any other appropriate data, which may be in addition to historical travel itineraries, as previously described. The knowledge augmentation data may be transformed, such as by any appropriate process or model, into an entity-based knowledge store, where the entities of the knowledge store may be any entities (e.g., vendors, locations, travelers, restaurants, memberships (such as rewards memberships), etc.) with which the user interacts. The entities of the knowledge store may or may not include the entity (such as employer, tour group, etc.) which is a sponsor of the user's travel. Based on the knowledge store, itineraries may be suggested, such as by Vox2i using, including in addition, any method as previously described. The knowledge augmentation may be added to a user's profile, such as a user's adaptive profile, or called up based on accessing of the user's profile. The objects (e.g., datasets, logs, stores, etc.) of knowledge augmentation, such as those depicted in FIG. 6, may be accessible to Vox2i during a preparation phase (such as the preparation phase 110 of FIG. 1) or at any other appropriate time.

Returning to the booking phase 150 of FIG. 1, in some embodiments, the booking phase 150 may feature the use of historical data to search for past TDPs matching the current request. If a match is found, in some embodiments, the itinerary (or itineraries, if several versions are found), may be checked for current policy and preferences compliance, such as by using the models and tools built during the preparation phase 110. If all checks are successful, in some embodiments, the specific (e.g., JSON script) template corresponding to the found itinerary may be used to check, in real time (e.g., at the operation 164), the availability of all its components using, such as by online booking tools, airline, hotel, ground transportation resources, etc. In some embodiments, an itinerary, which may be a complex itinerary, may be decomposed into a set of templates to match the various, possibly independent, sources of booking information. For example, a multi-leg trip may be decomposed into itineraries for each leg of the trip, a trip involving multiple modes of transportation may be decomposed into itineraries for each mode of transportation, etc.

A failure in any of these checks may results in a possibly iterative process (e.g., a return to the operation 162) which may require the relaxation of some constraints (e.g., commonsense constraints, soft constraints, and even, in some embodiments, hard constraints), which may occur by using the checking tool(s) (e.g., at the operation 164) and any information they provide about why an itinerary may have fail as a guide to eliminating or casing policy mandates or user preferences. In some embodiments, the same (or a similar) process may be triggered when an exact TDP match is not found. In some embodiments, this may trigger a mapping of preferences for other users or other TDP determined to be similar to the desired TDP onto the constraints. For example, if for a first user no available itineraries satisfy a set of preferences, a backup set of preferences may be imported, such as from the user's historical travel to a similar destination or from a second user identified as having similarities to the first user, to the same or a different destination.

In some embodiments, if more than one itinerary passes the checks in the booking phase (such as at the operation 164), the multiple itineraries may be presented as options to the traveler. In some embodiments, if no itinerary passed the checks (such as at the operation 164), alternative itineraries may be presented, including as annotated with their specific policy transgressions and traveler preferences unmet. In some embodiments, the order of presentation of itineraries may be in ascending order of strictness of the infringed policies, the relative weight of a traveler's preferences, or any other appropriate sorting mechanism, such as a confidence score

In some embodiments, the strictness or the quality of the itineraries relative to the policies and preferences may be measured, including by using an aggregated value based on the weights of the traveler's preferences and policy rules rigidity factors. The weights of the traveler's preferences may be measured, such as by using machine learning techniques (e.g., inverse reinforcement learning), while the rigidity factors may be assigned based on domain knowledge or statistical analysis. The aggregated measure may be defined as a convex combination of the weights and factors, which may be presented together with indicators for the specific policy rules or preferences being violated for each identified measure. In some embodiments, all rules and preferences may be equally weighted, and the aggregated measure may simplify to the number of instances a rule or preference was not satisfied (e.g., by the given itinerary). In some embodiments, the aggregated measure may be used as a score for ranking the different itineraries. In another embodiment, the ranking may be based on a similarity or affinity score calculated using embeddings created for the traveler and the alternative itineraries. In some embodiments, compliance information may be noted for each for itinerary, in a manner interpretable by an end user.

In some embodiments, Vox2i may ingest a travel request in any appropriate manner. For example, the travel request, in some embodiments, may be received through a voice or textual interface. In some embodiments, the travel request may be partially or substantially incomplete and may require the completion of missing information or the resolution of ambiguity, which may be specific to the request or the result of natural language constructs. This process is further detailed in the following.

In addition to traveler preferences and business policies, travel booking may need to consider other factors, such as those related to contractual terms of providers of travel-related services, e.g., airlines, hotels, ground transportation companies, corporate credit card issuers, etc. For example, a contract may specify a rebate contingent on the number of flights taken on a given airline between two specific cities or airports, the purchase of a minimum number of room-nights from properties belonging to a specific hotel brand, or a minimum spend charged to corporate credit cards. These contractual constraints may be incorporated into the travel booking process, in some embodiments, in addition to user preferences and corporate travel policies, in order to better address the objectives of a corporate travel program.

In some embodiments, the relative importance of contractual-based factors may be dynamic in nature, i.e., when a contractual term is met (e.g., for a given time period), its weight on travel planning may decrease, or in some cases is no longer in effect (e.g., for the rest of that time period). However, contractual-based factors may recur or be re-implemented periodically. This may require monitoring of contractual terms, in some embodiments, in order to provide greater operational efficiency.

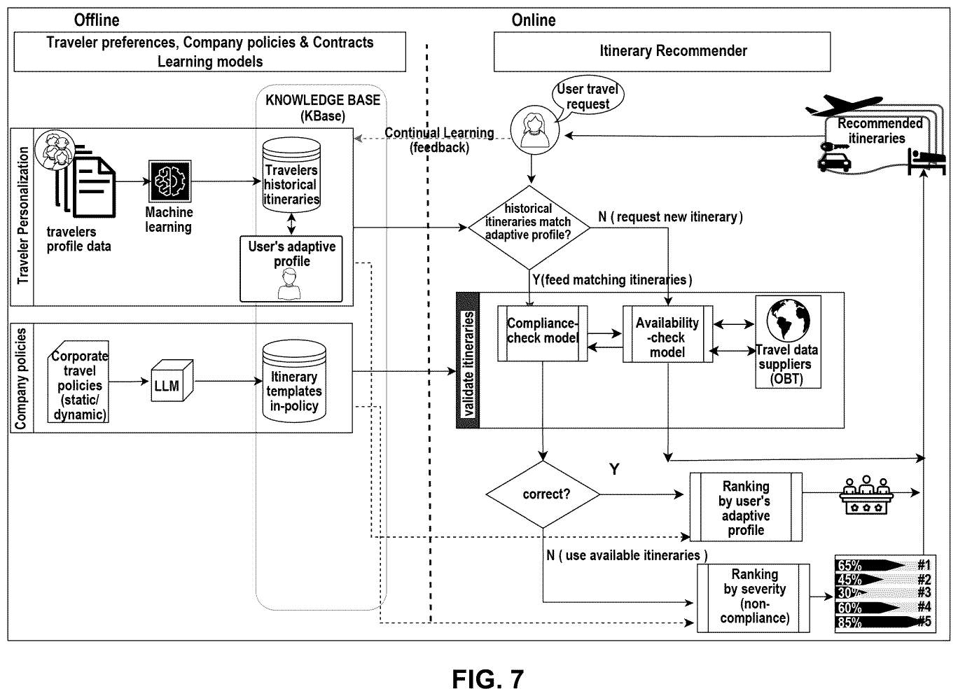

FIG. 7 is a schematic diagram 700 depicting example offline and online phases of a process for creation of an itinerary, in accordance with some embodiments. FIG. 7 may supplement, in some embodiments, the Vox2i process as described in FIG. 1 and other figures.

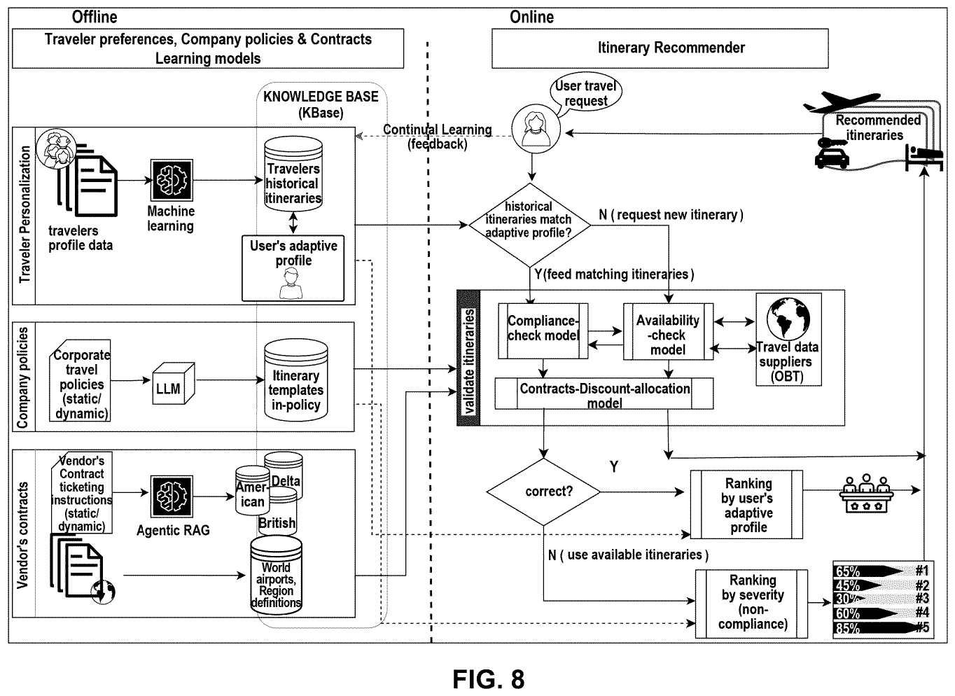

FIG. 8 is a schematic diagram 800 depicting example offline and online phases of a process for creation of an itinerary which complies with some contractual obligations, in accordance with some embodiments. FIG. 8 depicts, in some embodiments, how contracts may be included in Vox2i in order to incorporate their associated constraints into the decision-making process for booking travel. Further, in some embodiments, terms, or “rules”, may be contained in a contract and extracted for use by Vox2i, including during the preparation phase (e.g., the preparation phase 110 of FIG. 1).

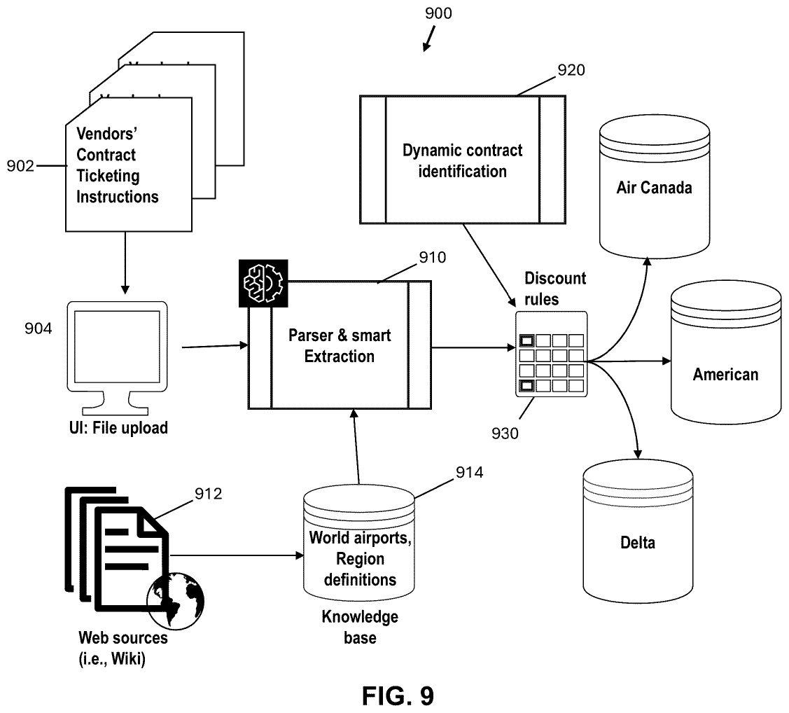

In some embodiments, it may be essential to incorporate contractual, policy, or other considerations into an optimization calculation for booking of a travel itinerary. This may, in some embodiments, require the ability to interpret natural language documents, such as contracts, in order to determine (e.g., locate and understand) these factors. In many cases, these documents may be provided in PDF format, thus necessitating a parsing process for extracting actionable, structured information from text, tables and figures contained within. An example description of the inputs and outputs of the contract parsing is presented in FIG. 9.

FIG. 9 is a schematic diagram 900 depicting parsing of vendor contracts in order to identify contractual obligations for itinerary creation, in accordance with some embodiments. In some embodiments, parsing of vendor contracts may include an ingestion process (e.g., at operation 910) to parse and extract contract rules (e.g., discount rules 930, where some discount rules may have a time period during which they are valid as depicted by shading) from vendor documents (e.g., vendor contract ticketing information 902). The parser and extractor may operate on the vendor documents supplied by any appropriate upload (e.g., at operation 904 which may be any appropriate operation include similar to the operation 404 of FIG. 4). In some embodiments, the parse and extractor may also operate on a knowledge base (e.g., knowledge base 914) which may contain information about locations, vendors, time zones, conversion rates, etc. which may be of use in travel and which may be obtained from any appropriate source (e.g., from a foundation model, from one or more web sources such as web source 912, etc.). In some embodiments, Vox2i may produce a list of discount rates, including sorted or otherwise considering multiple factors such as Origin and Destination (by cities, regions, countries, etc.), carriers (Delta, American, Air Canada, Amtrack, etc.), fare basic codes, identification of airport codes, currency in which discount is applied, etc.

In order to consider the dynamic component of contracts, in some embodiments, Vox2i may identify (e.g., tag) those discount rules (e.g. of the discount rules 930) which may have applicability restrictions, such as quotas or validity periods. During the booking phase (e.g., the booking phase 110 of FIG. 1), in some embodiments, a process may operate which monitors every time a given rule (for example, a flagged rule) is applied during booking (e.g., during purchase or acceptance of one possible itinerary) an itinerary in order to measure if the quota has been met, if the quota is on track to be met (e.g., a rate of rule application), etc. In some embodiments, the applied rule may be counted when an itinerary which fulfills it is actually traveled, or after such an itinerary is non-refundable (for example, within 24 hours of travel), etc. If a given quota is not met (or alternatively or additionally not on track to be met within a given time period), Vox2i may suggest to the user an itinerary which does meet the quota, or present to another user, such as a supervisory user, a warning to cause a search for another, complying vendor, including a vendor who may already be vetted to meet the itinerary's requirements (for example, suggest only Delta flights for travel itineraries if the Delta quota is within 1 trip, within 5 trips, etc. of being met, or, if the Delta quota is unlikely to be met in a given time period, choose itineraries on a cheapest carrier, whether that is Delta or not), or who may offer a more attractive discount (e.g., that the vendor of the discount rule) for the same trip. In some embodiments, Vox2i may, in some instances, restrict itineraries to a specific vendor in order to meet contractual requirements.

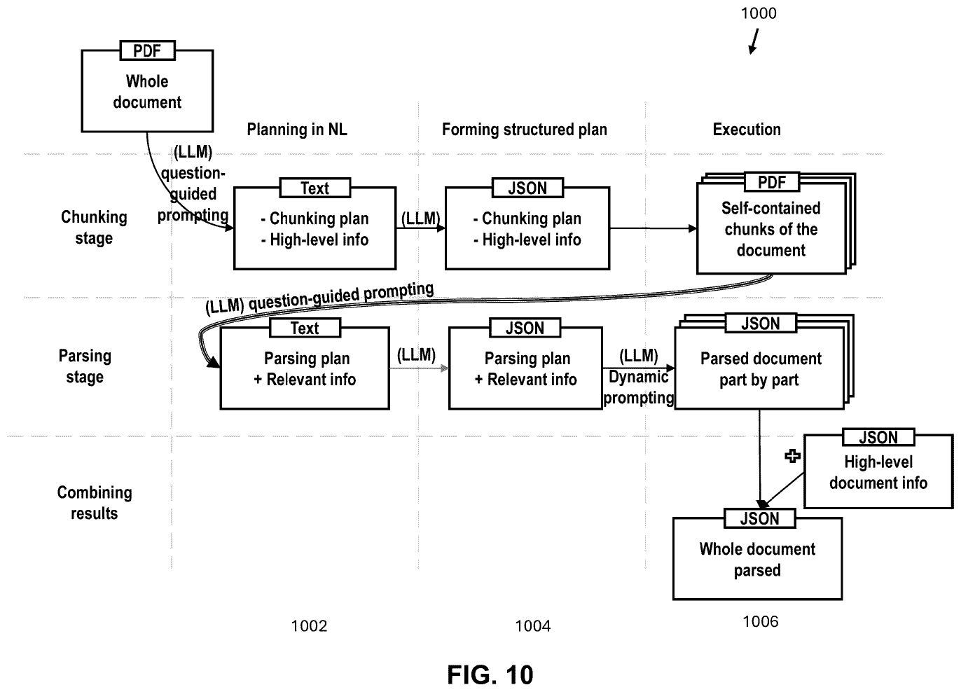

In some embodiments, Vox2i may include or be in communication with a system or method for parsing PDF files, such as to extract airfare discount rules from a contract between an airline and an enterprise customer. In addition to the airline-customer case (as provided in FIG. 10), this method is applicable to other contractual relationships and other scenarios as well, including the reconciliation of itemized bills to invoices, with or without a contract governing the transactions. The airline-customer case is presented as an illustrative case, which is not to disclaim any generalized rule extraction parsing method as applied in other domains. Nor is such parsing restricted to a document type, such as PDF. In some embodiments, parsing may be applied to any document (or audio file) containing natural language, structured language, etc., such as database formats, spreadsheets, etc.

### PDF Parsing Pipeline.

The PDF parsing pipeline may operate as a multi-phase, LLM-driven orchestration system to partition large files into smaller pieces (“chunking”)—where large and small are relative terms and do not restrict file size—by building LLM prompts, parsing, and merging for a given PDF (or other data source, as previously described).

FIG. 10 is a schematic diagram 1000 showing an example data parsing pipeline, in accordance with some embodiments. The stages throughout the pipeline may be structured in three steps, namely. 1) structured and dynamic planning by LLM in NL (in column 1002); 2) converting NL plan to structured JSON plan (in column 1004); and 3) plan execution (in column 1006). Each may be performed as detailed below. It should be understood that, in some embodiments, steps may overlap with one another, be non-sequential, concurrent, etc., and that steps described here may instead occur in more or fewer steps.

Step 1. Structured and dynamic planning by LLM in NL: the LLM may be asked a series of questions, which may be prepared questions elucidating various requirements for chunking, which may lead to a plan for a solution for the given stage of task. For example, during the chunking stage, the questions may include:
1. “How is the document organized? What sections are there?”
2. “Since the main goal is to gather the discount rules, which pages should the later steps focus on? And let's call them Discount Rule Pages”
3. “Should the Discount Rule Pages be split into smaller, self-contained sets of pages that can be processed independently?”

The LLM answers to the above questions may form a plan, such as a chunking plan.

During the parsing stage, some questions for planning may be as follows:
1. “How many discount rules are roughly in this chunk of PDF?”
2. “I'm using LLM {model_version}. Given that each LLM call can output limited number of tokens, does it require multiple LLM calls to output all the rules in this PDF?”
3. “Please explicitly provide exactly how you instruct the LLM in each call to parse the intended subset of rules.”

The LLM may determine during the actual parsing for a given chunk of the document, according to the planning, the need for multiple LLM calls (because of output token limit). If that is the case, the pre-planned prompt instructions for each call may be incorporated into each prompt to instruct the LLM on which discount rules to extract.

Although LLMs may be able to approximate reasoning on their own, the question-guided querying of the LLM may be more efficient and may act as a guarantee on the quality of results.

Step 2. Converting NL plan to structured JSON plan: the fields in the JSON plan may be pre-prepared in order to contain necessary inputs for an execution step. The conversion itself may be straightforward, such as by asking an LLM to convert the text (from the planning step) to JSON, but may also be more complicated, in some embodiments.

Step 3. Plan execution: the input values for execution may be in the generated JSON. Also, a list of start and end page numbers for each section may be available to perform chunking, as well as the subset of rules to use in parsing.

The output from every step (either text or JSON) may be saved, reviewed, even edited by a human-in-the-loop for quality control to make sure the steps downstream are executed correctly.

This framework of automated document parsing is proven to work for air contracts, for which a result is shown below, but the technique is transferable to other types of documents, other tasks, etc. For example, the input file may contain images, html, etc.

In addition to JSON, the output file may be yaml, xml, csv, etc.

Furthermore, in addition to contract parsing, the framework may be used for tasks such as contract and bill reconciliation for a corporate event, or other information extraction tasks where the input and output are too large to process using a single LLM call.

Hereinafter is provided an example of document parsing by the above described pipeline applied to a publicly available air contract between United Airlines and the University of Virginia (https://uvafinance.virginia.edu/sites/uvafinance/files/United%20agreement_0.pdf), to extract the discount rules in a PDF document written in English and produce a structured template.

The following transformations may happen, including automatically throughout the pipeline: the discount rules may be identified, such as identified as being located in pages 6-69; the discount rule pages may be split, such as by being split into 15 chunks, in the below example; each PDF chunk may be parsed with one or multiple LLM calls; the parsed discount rules may be combined, including at the end of the parsing or other evaluation process. Some sample parsed discount rules are provided below, using an example from page 51 of the above identified PDF file.
{
   “parsed_discounts”: [//* Rule Identification *//
      {
         “discount_rule_sequence_number”: 4,
         “term_name”: “ ”
         “discount_rule_name”: “Discount 4: USA to EMEA/I YBMHU”,
         “market_pairs”: [
         {
         “origin_airports_or_regions”: [//* Origin & Destination *//
         “United States”
         ],
         “destination_airports_or_regions”: [
         [“Africa”,
         “Europe”,
         “Middle East (cg)”,
         “India”
         ],
         “exclude_origin_airports_or_regions”: [ ],
         “exclude_destination_airports_or_regions”: [ ],
         “bidirectional_or_directional”: “Directional”
         }
         ],
         “one_way_or_round_trip”: [ ], //* Itinerary Parameters *//
         “include_connection_airports_or_regions”: [ ],
         “exclude_connection_airports_or_regions”: [ ],
         “cabin_class”: [ ], //* Fares & Discounts *//
         “fare basis_starts_with”: [
         “Y”
         “B”,
         “M”,
         “H”,
         “U”
         ],
         “fare_basis_equals”: [ ],
         “fare_basis_not_equals”: [ ],
         “fare_basis_contains”: [ ],
         “service_class”: [ ],
         “fare_category”: [ ],
         “discount_rate”: 0.08,
         “fixed_fare”: 0.0,
         “fixed_fare_currency”: “ ”,
         “marketing_carrier”: [//* Carriers *//
         “United Airlines”,
         “Lufthansa”,
         “SWISS”,
         “Austrian Airlines”,
         “Brussels Airlines”,
         “Air Canada”,
         “Eurowings”
         ],
         “validating_carrier”: [
         “Air Canada”,
         “United Airlines”,
         “Lufthansa”,
         “SWISS”,
         “Austrian Airlines”,
         “All Nippon Airways”,
         “Brussels Airlines”
         ],
         “operating_carrier”: [
         “United Airlines”,
         “Lufthansa”,
         “SWISS”,
         “Austrian Airlines”,
         “Brussels Airlines”,
         “Edelweiss Air”,
         “Air Canada”,
         “Eurowings”
         ],
         “discount_specific_notes”: “ ”,
“discount_rule_start_page_number_in_file_chunk”: 2, //* Location in Doc *//
   “discount_rule_end_page_number_in_file_chunk”: 2,
   “discount_rule_page_number_start”: 51,
   “discount_rule_page_number_end”: 51
},
{
   “discount_rule_sequence_number”: 5,
   “term_name”: “ ” “discount_rule_name”:
   “Discount 5: USA to EMEA/I GEO”,
   “market_pairs”: [
      {
         “origin_airports_or_regions”: [
         “United States”
         ],
         “destination_airports_or_regions”: [“Africa”, [
         “Europe”,
         “Middle East (cg)”,
         “India”
         ],
         “exclude_origin_airports_or_regions”:
         “exclude_destination_airports_or_regions”: [ ],
         “bidirectional_or_directional”: “Directional”],
      }
   ],
   “one_way_or_round_trip”: [ ],
   “include_connection_airports_or_regions”: [ ],
   “exclude_connection_airports_or_regions”: [ ],
   “cabin_class”: [ ],
   “fare_basis_starts_with”: [
      “G”,
      “E”
      “O”
   ],
   “fare_basis_equals”: [ ],
   “fare_basis_not_equals”: [ ],
   “fare_basis_contains”: [ ],
   “service_class”: [ ],
   “fare_category”: [ ],
   “discount_rate”: 0.05,
   “fixed_fare”: 0.0,
   “fixed_fare_currency”: “ ”,
   “marketing_carrier”: [
      “United Airlines”,
      “Lufthansa”,
      “SWISS”,
      “Austrian Airlines”,
      “Brussels Airlines”,
      “Air Canada”,
      “Eurowings”],
   ],
      “validating_carrier”: [
      “Air Canada”,
         “United Airlines”,
         “Lufthansa”,
         “SWISS”,
         “Austrian Airlines”,
         “All Nippon Airways”,
         “Brussels Airlines”],
      ],
      “operating_carrier”: [
         “United Airlines”,
         “Lufthansa”,
         “SWISS”,
         “Austrian Airlines”,
         “Brussels Airlines”,
         “Edelweiss Air”,
         “Air Canada”,
         “Eurowings”],
      ],
      “discount_specific_notes”: “ ”,
      “discount_rule_start_page_number_in_file_chunk”: 2,
      “discount_rule_end_page_number_in_file_chunk”: 2,
      “discount_rule_page_number_start”: 51,
      “discount_rule_page_number_end”: 51}]
   }
}

According to the above, if a customer books a flight from JFK airport in New York to LHR airport in London (the United Kingdom is inside the EMEA/I region), with fare basis Y on United Airlines, a search through the parsed contract shows the fare is eligible for an 8% discount (according to Rule 4, which applies to YBMHU (e.g., an example fare code) fares). Additionally, an extracted rule 5 covers the same USA and EMEA/I geographies but offers only a 5% discount for GEO fares.

In some embodiments, multiple LLMs (or multiple LLM queries), such as in an agent-oriented planning orchestration, may be used for parsing and extracting information from contracts, invoices, policies and many other business documents (found in PDF format or other formats). The process of agent-oriented planning consists of a fast decomposition and allocation task that heavily relies on the capabilities of a planner agent and the rigorously design of system prompts, examples of which are found in Li, A., Xie, Y., Li, S., Tsung, F., Ding, B., and Li, Y. (2024). Agent-Oriented Planning in Multi-Agent Systems. https://arxiv.org/abs/2410.02189, the contents of which are hereby incorporated by reference.

In some embodiments, when given a task (for example, parsing contracts), the agent planner may serve as a controller within these systems. The agent planner may operate based on two primary responsibilities: (1) comprehend the task and decompose it into several sub-tasks and (2) assign these sub-tasks to the appropriate agents for execution. Then, a team of expert agents (which may be human agents, but also or instead may be agentic models, chatbots, LLMs, etc.) with predefined tasks may deal with the different pieces of the contract (e.g., those previously identified by a human engineer or another agent or model), which may involve converting the documents into simpler rules by analyzing images, extracting data, generating test examples, evaluating the results, identifying unknown elements (e.g., regions, countries, domestic, international, cities, airports, finding the correct list of regions, finding airport codes) by using Web Search tools, etc.

In some embodiments, two elements of this multi-agentic system may be the evaluator agent and the reviewer Agent. The evaluator agent may be used to test and evaluate the results, and to alert if the accuracy (e.g., an accuracy threshold) is not reached. If the desired accuracy is obtained, an output agent may be assigned to properly format and generate the final contract discount rules for further use, e.g., in the booking phase. The reviewer agent may be responsible for evaluating the performance of the other expert agents, making timely adjustments to the sub-tasks, keeping a feedback loop to further enhance the effectiveness and robustness of such a problem-solving process, or other review processes.

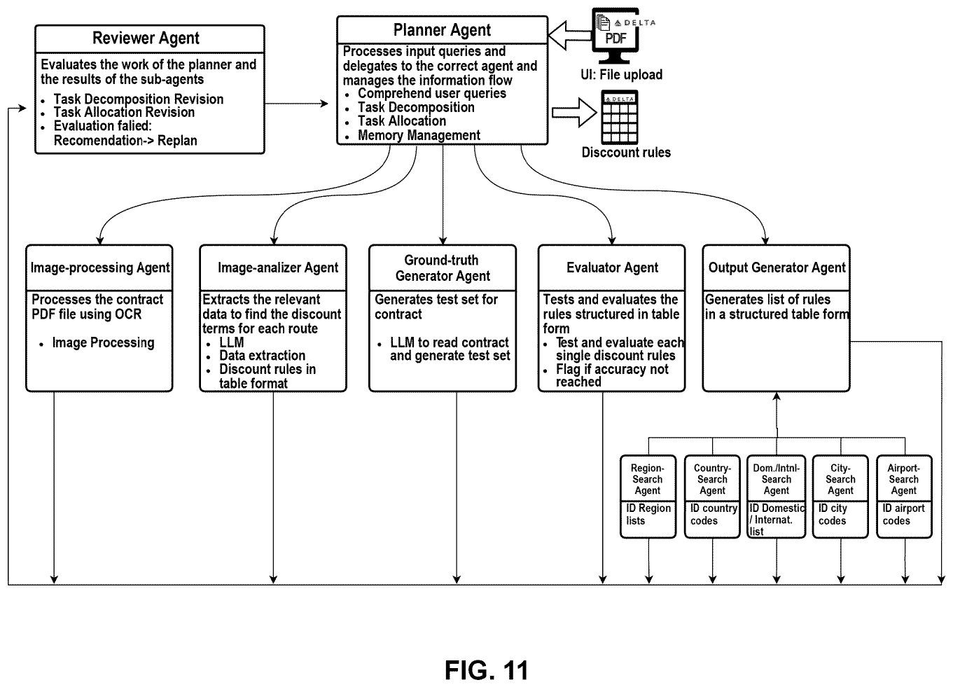

FIG. 11 is a schematic diagram 1100 depicting parsing of a contract using a multi-agent workflow, in accordance with some embodiments. Diagram 1100 depicts multiple agents, which may operate with (or in communication with) a parsing operation. The agents may include reviewer agents, planner agents, image-processing agents, image-analyzer agents, ground-truth generator agents, evaluator agents, output generator agents, or any other appropriate agents, including agents combining tasks or performing sub-tasks of those operations shown.

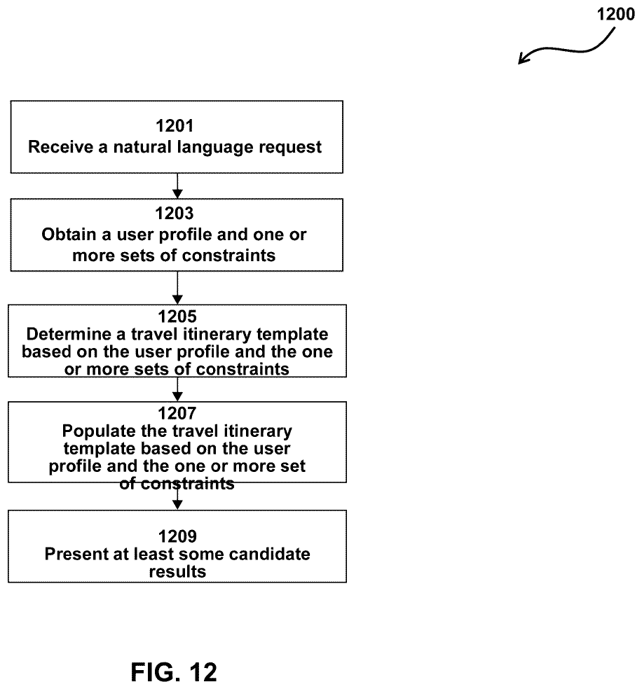

FIG. 12 is flowchart of a process for handling natural language ambiguity, in accordance with some embodiments. Embodiments of the example process 1200 may be performed by a computing system, such as a computing system implementing a natural language processing service in accordance with the techniques described herein.

In some embodiments, the process includes receiving 1201 a natural language request through a user interface, to produce analytic results from a collection of data. For example, the system may receive a request to “show top travelers” directed at an analytics platform containing business travel information. A natural language processing service may, for example, determine whether the request was made through a spoken or text natural language input or pointed input. In some examples, if the natural language request was made through spoken input, the natural language processing service may then need to convert the spoken input to text input for processing, through a speech-to-text step. In another example, if the natural language request is made by text or pointed input, the natural language processing service may then begin the process of transforming the request into visual data representations, through a text-to-text step.

In some embodiments, the process includes obtaining 1203 a user profile and one or more sets of constraints. The one or more sets of constraints may include constraints contained within the user profile. The user profile may be a self-adjusting user profile, a static user profile, a generic user profile (for example, a user profile for substantially all users of a group to which a given user belongs, etc.). The set of constraints may include a set of hard constraints, which may be unavoidable constraints. Hard constraints may be constraints extracted from travel policy documents or otherwise be associated with policy documents, corporate rules, etc. The set of constraints may include a set of soft constraints, which may be preferences, including user preferences. The set of constraints may include a set of commonsense constraints, which may be universal constraints, including constraints hardcoded (e.g., during onboarding) or learned based on human behavior.

In some embodiments, the process includes determining 1205 a travel itinerary template based on the user profile and the one or more set of constraints. The travel itinerary template may be determined in any appropriate manner, including those previously described above.

In some embodiments, the process includes populating 1207 the travel itinerary template based on the user profile and the one or more sets of constraints. The template may be populated in any appropriate manner, including those previously described above.

In some embodiments, the process includes presenting 1209 at least some candidate results to a user. The results may be ranked by any appropriate method. The results may be constrained by availability, desirability, one or more corporate policy, one or more contractual obligation, etc. The results may be presented or stored in any appropriate manner, including by electronic, digital, physical, etc. means.

Some embodiments differ from other approaches in ways that are expected to afford various advantages. Some approaches to conversational travel planning treat a natural-language request as a query over commodity inventory and then apply policy checks as a post-processing filter, which can create brittle results and frequent rejections when constraints conflict. In some embodiments, constraint reasoning is integrated into candidate construction itself. Hard, soft, and commonsense constraints may be injected at template selection time and preserved through component assembly, so that generated options tend to be feasible and policy-aligned before ranking occurs. Some embodiments may attach policy-severity weights to constraints, allowing lower-priority preferences to yield to higher-priority rules during optimization rather than failing late.

Some approaches to travel planning rely on static user profiles composed of a few stated preferences or recently observed clicks, which can misrepresent a traveler in new contexts. In some embodiments, the profile may be self-adjusting, combining declared preferences with inferences drawn from similar travelers, group-level patterns, and traveler-destination pairs that generalize to first-time routes. These profiles may update as outcomes and feedback accrue, and may carry confidence and provenance indicators so downstream decisions can privilege reliable signals while exploring uncertain ones conservatively.

Some approaches to travel planning assume that negotiated rates and eligibility rules arrive in fully structured feeds and therefore avoid the variability of real contracts, which leaves significant value untapped when terms live in PDFs, emails, or portals. In some embodiments, a question-guided parsing pipeline may extract structured rules from unstructured contract materials using specialized agents, and may store those rules with audit trails, confidence scoring, and testable predicates. During planning and booking, these rules may be invoked alongside public inventory so that quota usage, blackout windows, and eligibility conditions are enforced automatically, and suggestions may be steered to satisfy volume or corridor commitments without manual intervention.

Many approaches to travel planning present results as a flat list assembled by heuristic scoring or price sorting and then ask the user to piece together the trip. In some embodiments, a template-driven decomposition may be used to shape the itinerary into sub-itineraries and components, such as air, lodging, and ground, each populated under the same constraint set. Some embodiments may use embedding-based retrieval to surface similar historical trips as seeds and then refine them against current availability, policy rigidity factors, and learned utility functions. Candidate sets may be ranked by a composite objective that accounts for preference fit, policy severity, and contract value realization, and may be presented with abbreviated rationales and confidence indicators to speed user acceptance.

Many approaches to travel planning expose voice input only as a front end to search and stop short of completing transactions, requiring a handoff to human or manual entry in web forms. In some embodiments, a conversational loop may continue through booking using web automation, vendor APIs, or approved agents, while preserving constraint proofs and policy checks that led to the selection. This continuity may reduce failure modes where the booked outcome diverges from the suggested option and may support automated remediation when availability changes mid-flow.

Many approaches to travel planning run in a single pass and rebuild context on every request, which increases latency and reduces consistency across a traveler's trips. In some embodiments, a preparation phase may precompute templates, policy embeddings, eligibility classifiers, and contract-rule indices for a population or cohort, with a distinct implementation phase that executes rapid personalization and availability checks at request time. This separation may yield faster responses, higher acceptance rates, and better cross-trip coherence, especially when combined with live counters for negotiated quotas and feedback-driven adjustments to preference weights.

It should be emphasized that the present techniques address specific technical problems with specific technical improvements that may be included in some embodiments. Many approaches to conversational itinerary planning treat natural-language input as a loose search string, enumerate a large candidate set, and apply policy filters after the fact, which consumes CPU and network resources on options that will be discarded. In some embodiments, constraint reasoning is moved forward into template selection and component assembly. Hard, soft, and commonsense constraints may be compiled into a machine-interpretable structure, such as a constraint lattice or finite-state policy automaton, that prunes infeasible branches before any live inventory queries are issued. By transforming policy and preference rules into executable structures and running early constraint propagation, some embodiments reduce combinatorial explosion, lower memory pressure, and shorten end-to-end latency relative to post-filter pipelines, thereby improving computer efficiency in how itineraries are generated.

Many approaches to travel planning model user preferences as static key-value records updated sporadically, which forces downstream systems to re-score from scratch and to over-query external services on each request. In some embodiments, an adaptive profile may be represented as a set of sparse embeddings paired with confidence and provenance metadata and incrementally updated with each interaction. This representation can be cached and partially evaluated against itinerary templates during a preparation phase, so that at request time the system executes only a small number of vector similarity checks and differential updates. The result is expected to include reduction in CPU cycles and network calls required to rank candidates, improving the functioning of the computer through better data locality and reuse.

Many approaches rank travel options with ad-hoc heuristics that can violate policy monotonicity, forcing repeated recomputation when a single constraint changes. In some embodiments, scores may be computed by a composite objective that incorporates policy-severity weights and monotone penalty functions, affording incremental re-ranking when a constraint is toggled. By structuring the objective to support incremental updates and by caching intermediate terms, some embodiments avoid full rescoring and re-fetching, improving processor utilization and response time in the ranking subsystem.

Many approaches handle voice input as a single, blocking transcription step, delaying downstream computation until the entire utterance is recognized. In some embodiments, streaming speech-to-text with on-device voice activity detection may emit partial hypotheses tagged with stability scores, which feed an incremental semantic parser capable of speculative template selection. As a result, constraint propagation and availability probing can begin before transcription completes, shortening perceived latency and distributing compute more evenly over time. This is a concrete improvement in how the computer orchestrates multimodal input and pipeline parallelism.

It is important that terms used in this application be consistent with described embodiments, including those above and that follow. In some embodiments, instances of a natural language request include typed and spoken inputs, single-turn or multi-turn exchanges, and streaming utterances that yield partial hypotheses, and are processed with contextual signals from the user interface rather than reduced to keyword matching. In some embodiments, instances are not limited to voice audio, are not confined to a single message, and are not treated merely as a generic search string.

In some embodiments, instances of a user profile are self-adjusting rather than static, incorporate signals derived from outcomes and feedback, and include indicators that distinguish stronger signals from exploratory ones. In some embodiments, instances are not an undifferentiated dump of all user data and are not confined to a fixed, minimal set of fields; they reflect a bounded, machine-interpretable structure oriented toward itinerary construction.

In some embodiments, instances of sets of constraints exhibit distinct operational behavior for hard, soft, and commonsense categories and may be updated over time from multiple sources, including learned or generated signals. In some embodiments, instances are not limited to a handful of canned examples, not confined to hardcoded rules, and not so broad as to encompass any arbitrary guideline without category structure.

In some embodiments, instances of a travel itinerary template are compositional and decomposable into sub-itineraries and components with associated validation logic, rather than a single monolithic form. In some embodiments, instances are not restricted to one fixed schema and are not merely generic placeholders lacking structural semantics.

In some embodiments, instances of populating a template involve constraint-driven selection, composition, and availability verification of components sourced from multiple systems, potentially with iterative refinement. In some embodiments, instances are not limited to filling preexisting fields with already chosen items and are not confined to display formatting.

In some embodiments, instances of candidate results are machine-generated artifacts produced by the pipeline and may be ranked and stored with associated condensed descriptors and confidence indicators tied to underlying evidence. In some embodiments, instances are not limited to any particular screen layout and are not indefinite placeholders lacking computable scores or provenance.

In some embodiments, instances of a traveler destination pair apply to a pairing between a traveler context and a destination context at varying levels of granularity and may be used to seed or infer preferences even where historical data is sparse. In some embodiments, instances are not confined to a single traveler and single city, and are not so vague as to exclude actionable pairing behavior.

In some embodiments, instances of parsing use cooperating software processes that plan, form structured actions, and execute controlled extractions to yield typed, machine-checkable rules, potentially with deterministic post-parsers and validation. In some embodiments, instances are not generic text scraping and are not limited to precisely two predetermined agent roles.

In some embodiments, instances of a pre-implementation phase include technical staging such as precomputation, indexing, and compilation of models and rules for later low-latency access in an implementation phase that performs rapid personalization and availability checks. In some embodiments, instances are not merely business timing labels and are not tied to a single deployment topology.

In some embodiments, instances of a web agent carry typed actions, transactional safeguards, and fallbacks to vendor APIs or applications to complete bookings while preserving state and invariants. In some embodiments, instances are not limited to brittle replay of user-interface clicks and are not restricted to any particular vendor-specific bot.

Embodiments may ingest natural language text, which has sequences of characters or tokens that follow grammatical rules and stylistic conventions associated with human languages such as English, Mandarin, or Arabic, but which do not adhere to fixed schemas or predefined syntactic structures beyond those associated with natural grammar. Natural language text may include ambiguities, implied meanings, idioms, and context-dependent semantics, and may vary significantly in word choice, sentence structure, and punctuation. In contrast, structured language text consists of symbol sequences that conform to explicitly defined syntactic and semantic constraints. Structured language text may include programming languages, markup languages, or data serialization formats such as JavaScript Object Notation (JSON), Extensible Markup Language (XML), or YAML Ain′t Markup Language (YAML). Each element in structured text may be associated with a well-defined type, and the syntactic structure may be represented by an abstract syntax tree or graph that preserves hierarchical relationships among elements. Structured language text lacks ambiguity in tokenization, parsing, or interpretation, such that machine-based processing can occur deterministically or with bounded nondeterminism based on formal grammars, such as context-free grammars or regular grammars.

The above approaches are, in some cases, expected to mitigate issues with other techniques. Discussion of such issues here and above should not be read to imply that the features giving rise to those issues are disclaimed or disavowed. Further, discussion of advantages here and above should not be read to imply embodiments are limited to systems exhibiting all of those advantages.

FIG. 13 is a diagram that illustrates an exemplary computing system 1001 in accordance with embodiments of the present technique. A single computing device is shown, but some embodiments of a computer system may include multiple computing devices that communicate over a network, for instance in the course of collectively executing various parts of a distributed application. Various portions of systems and methods described herein may include or be executed on one or more computer systems similar to computing system 1001. Further, processes and modules described herein may be executed by one or more processing systems similar to that of computing system 1001.

Computing system 1001 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1001. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1001 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1001 may include a plurality of computing devices (e.g., distributed computer systems) to implement various processing functions.

I/O device interface 1030 may provide an interface for connection of one or more I/O devices 1060 to computer system 1001. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1001 through a wired or wireless connection. I/O devices 1060 may be connected to computer system 1001 from a remote location. I/O devices 1060 located on remote computer system, for example, may be connected to computer system 1001 via a network and network interface 1040.

Network interface 1040 may include a network adapter that provides for connection of computer system 1001 to a network. Network interface May 1040 may facilitate data exchange between computer system 1001 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1001 or multiple computer systems 1001 configured to host different portions or instances of embodiments. Multiple computer systems 1001 may provide for parallel or sequential processing/execution of one or more portions of the techniques described herein.

Those skilled in the art will appreciate that computer system 1001 is merely illustrative and is not intended to limit the scope of the techniques described herein. Computer system 1001 may include any combination of devices or software that may perform or otherwise provide for the performance of the techniques described herein. For example, computer system 1001 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1001 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1001 may be transmitted to computer system 1001 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine-readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompass substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments.

1. A method for generating one or more travel itineraries, comprising: receiving, with a computer system, a natural language request that relates to a travel itinerary; obtaining, with the computer system, a user profile and one or more sets of constraints corresponding to the natural language request; determining, with the computer system, a travel itinerary template, based on the user profile and the one or more sets of constraints; populating, with the computer system, the travel itinerary template with a plurality of travel components based on the user profile and the one or more set of constraints; and presenting, with the computer system, at least some candidate results, the candidate results stored in memory.

2. The method of embodiment 1, wherein a natural language request is received through a user interface.

3. The method of embodiment 1, wherein a natural language request is a voice input converted to text with a speech-to-text model.

4. The method of embodiment 1, wherein the user profile is generated based on preference answers received from a user.

5. The method of embodiment 1, wherein the user profile is generated based on user profiles from users similar to a given user.

6. The method of embodiment 1, wherein the user profile is a self-adjusting user profile.

7. The method of embodiment 1, further comprising steps for updating the user profile.

8. The method of embodiment 1, further comprising steps for extracting constraints from one or more documents.

9. The method of embodiment 1, wherein the sets of constraints comprise at least one of the following a set of hard constraints, a set of soft constraints, and a set of commonsense constraints, wherein the set of hard constraints are associated with one or more travel policy, wherein the set of soft constraints are associated with user preference, and wherein the set of commonsense constraints are hardcoded.

10. The method of embodiment 1, wherein the sets of constraints comprise at least the following a set of hard constraints, a set of soft constraints, and a set of commonsense constraints, wherein the set of hard constraints are associated with one or more travel policy, wherein the set of soft constraints are associated with user preference, and wherein the set of commonsense constraints are hardcoded.

11. The method of embodiment 9, wherein the set of hard constraints comprises constraints extracted from one or more documents by parsing.

12. The method of embodiment 11, wherein the parsing is performed by one or more agents, the agents comprising at least one of the following: a reviewer agent and an evaluator agent.

13. The method of embodiment 11, wherein the parsing is performed by a reviewer agent and an evaluator agent.

14. The method of embodiment 11, wherein the parsing further comprises at least one of the following: a natural language-based planning, forming structured actions, and implementing structured actions.

15. The method of embodiment 1, further comprising generating the user profile and the one or more set of constraints in a pre-implementation phase, wherein the user profile and the one or more set of constraints are accessed in an implementation phase.

16. The method of embodiment 1, wherein presenting the at least some candidate results further comprises ranking the at least some candidate results and presenting the ranked candidate results according to their ranking.

17. The method of embodiment 1, further comprising booking a travel itinerary of the at least some candidate results.

18. The method of embodiment 17, wherein booking the travel itinerary comprises booking through a web agent, website, vendor application, or an API at least one component of the travel itinerary.

19. The method of embodiment 1, wherein the travel itinerary template is associated with a traveler destination pair (TDP).

20. The method of embodiment 1, wherein determining the travel itinerary template further comprises splitting the travel itinerary into sub-itineraries and determining a plurality of travel itinerary templates based on the sub-itineraries.

21. A tangible, non-transitory, machine-readable medium storing instructions that when executed by one or more processors effectuate operations comprising: receiving, with a computer system, a natural language request that relates to a travel itinerary; obtaining, with the computer system, a user profile and one or more sets of constraints corresponding to the natural language request; determining, with the computer system, a travel itinerary template, based on the user profile and the one or more sets of constraints; populating, with the computer system, the travel itinerary template with a plurality of travel components based on the user profile and the one or more set of constraints; and presenting, with the computer system, at least some candidate results and their associated abbreviated information, based on a confidence score of each result.

What is claimed is:

1. A method for generating one or more travel itineraries, comprising:
receiving, with a computer system, a natural language request that relates to a travel itinerary;
obtaining, with the computer system, a user profile and one or more sets of constraints corresponding to the natural language request;
determining, with the computer system, a travel itinerary template, based on the user profile and the one or more sets of constraints;
populating, with the computer system, the travel itinerary template with a plurality of travel components based on the user profile and the one or more set of constraints; and
presenting, with the computer system, at least some candidate results, the candidate results stored in memory.

2. The method of claim 1, wherein a natural language request is received through a user interface.

3. The method of claim 1, wherein a natural language request is a voice input converted to text with a speech-to-text model.

4. The method of claim 1, wherein the user profile is generated based on preference answers received from a user.

5. The method of claim 1, wherein the user profile is generated based on user profiles from users similar to a given user.

6. The method of claim 1, wherein the user profile is a self-adjusting user profile.

7. The method of claim 1, further comprising steps for updating the user profile.

8. The method of claim 1, further comprising steps for extracting constraints from one or more documents.

9. The method of claim 1, wherein the sets of constraints comprise at least one of the following a set of hard constraints, a set of soft constraints, and a set of commonsense constraints, wherein the set of hard constraints are associated with one or more travel policy, wherein the set of soft constraints are associated with user preference, and wherein the set of commonsense constraints are hardcoded.

10. The method of claim 1, wherein the sets of constraints comprise at least the following a set of hard constraints, a set of soft constraints, and a set of commonsense constraints, wherein the set of hard constraints are associated with one or more travel policy, wherein the set of soft constraints are associated with user preference, and wherein the set of commonsense constraints are hardcoded.

11. The method of claim 9, wherein the set of hard constraints comprises constraints extracted from one or more documents by parsing.

12. The method of claim 11, wherein the parsing is performed by one or more agents, the agents comprising at least one of the following: a reviewer agent and an evaluator agent.

13. The method of claim 11, wherein the parsing is performed by a reviewer agent and an evaluator agent.

14. The method of claim 11, wherein the parsing further comprises at least one of the following: a natural language-based planning, forming structured actions, and implementing structured actions.

15. The method of claim 1, further comprising generating the user profile and the one or more set of constraints in a pre-implementation phase, wherein the user profile and the one or more set of constraints are accessed in an implementation phase.

16. The method of claim 1, wherein presenting the at least some candidate results further comprises ranking the at least some candidate results and presenting the ranked candidate results according to their ranking.

17. The method of claim 1, further comprising booking a travel itinerary of the at least some candidate results.

18. The method of claim 17, wherein booking the travel itinerary comprises booking through a web agent, website, vendor application, or an API at least one component of the travel itinerary.

19. The method of claim 1, wherein the travel itinerary template is associated with a traveler destination pair (TDP).

20. The method of claim 1, wherein determining the travel itinerary template further comprises splitting the travel itinerary into sub-itineraries and determining a plurality of travel itinerary templates based on the sub-itineraries.

21. A tangible, non-transitory, machine-readable medium storing instructions that when executed by one or more processors effectuate operations comprising:
receiving, with a computer system, a natural language request that relates to a travel itinerary;
obtaining, with the computer system, a user profile and one or more sets of constraints corresponding to the natural language request;
determining, with the computer system, a travel itinerary template, based on the user profile and the one or more sets of constraints;
populating, with the computer system, the travel itinerary template with a plurality of travel components based on the user profile and the one or more set of constraints; and
presenting, with the computer system, at least some candidate results and their associated abbreviated information, based on a confidence score of each result.
